(19) United States
(12) Patent Application Publication
(10) Pub. No.: US 2023/0356085 A1
(43) Pub. Date: Nov. 9, 2023

(54) CONSTRUCTIVE FEEDBACK MECHANISM IN A VIDEO GAME ENVIRONMENT

(71) Applicant: Travertine Design Engine LLC, Rancho Santa Fe, CA (US)

(72) Inventors: Jason Hall, Los Angeles, CA (US); Randy Culley, Granite Falls, WA (US)

(21) Appl. No.: 18/224,824

(22) Filed: Jul. 21, 2023

Related U.S. Application Data
(63) Continuation-in-part of application No. 17/529,056, filed on Nov. 17, 2021.
(60) Provisional application No. 63/401,780, filed on Aug. 29, 2022.
(60) Provisional application No. 63/115,585, filed on Nov. 18, 2020.

(51) Int. Cl. A63F 13/57; A63F 13/814

(52) U.S. Cl. CPC A63F 13/57; A63F 13/814

(57) ABSTRACT

Computer-implemented methods, products, and systems for controlling animated renderings on a display device communicatively coupled to a controller device are provided. The system comprises one or more processors for executing logic code causing the one or more processors to perform operations comprising: associating a plurality of animation segments, graphically implemented over a video game platform, to a plurality of corresponding virtual cards in a first virtual deck, a virtual card in the plurality of virtual cards being selectable by a user for animating an avatar displayed on the display device, the avatar being animatable according to movements captured in a corresponding animation segment in the plurality of animation segments included in a virtual card selected by the user.

### CROSS-REFERENCE TO RELATED APPLICATIONS

The present application claims priority to and the benefit of the earlier filing dates of Provisional Patent Application Ser. No. 63/115,585 filed on Nov. 18, 2020; Non-Provisional patent application Ser. No. 17/529,056 filed on Nov. 17, 2021; and Provisional Patent Application Ser. No. 63/401,780 filed Aug. 29, 2022, the contents of which are hereby incorporated by reference herein in entirety.

### TECHNICAL FIELD

The disclosed subject matter generally relates to constructive feedback mechanisms and graphical user interface features in a virtual environment and, more particularly, to choreographed movements in the form of animated segments created for custom animation routines for one or more virtual characters.

### BACKGROUND

Video games are among the most popular sources of entertainment. A game typically includes a group of virtual characters, referred to as avatars, who act as the protagonists or antagonists in the game's storyline. Each avatar usually has a limited set of predefined features. Typically, a finite number of animated movements are specifically, and often exclusively, prescribed for an avatar. Players of most video games tend to grow fond of certain avatars because of the exclusive functional features (i.e., powers) or visual characteristics (i.e., skin) of that avatar. As a player continues to select the same avatar during a game, the player becomes more skilled in utilizing that avatar's special moves and features.

A player who wishes to be competitive often chooses the avatar with which the player has the most practice and comfort level. This allows the player a better chance of success against an opponent. While a player may like or prefer the graphical features (e.g., the visual design and skin) of a favorite avatar, the player may like the moves or functional features of another avatar better, and vice versa. Unfortunately, a player is generally unable to configure a first avatar with the functional features and characteristics of a second avatar. Further, a player is typically not allowed to add new features to an avatar or easily change or customize the avatar with selectable moves or features. In other words, in the state of the art commercial video game technologies, the typically functional and visual features of an avatar are exclusively fixed for that avatar.

Another disadvantage associated with some popular competition-based video games is that the game developers tend to rely on violence and militant storylines. Often, such features appeal to the lowest most basic common denominators of human character and are unsuitable for many players, particularly the young. The instinctive attraction of players to violence has led to the perpetual success of some of the most popular video games over the years, such as Street Fighter™ in the 1980s and Mortal Combat™ in the 1990s. Many games in circulation today continue to glorify criminal activity, destruction and death, in games series such as Call of Duty,™ Grand Theft Auto,™ and Fortnite.™

Unfortunately, the ever increasing violence and criminal homicide, involving active shooters, has been associated with the seamless interaction and immersion of individuals in violent video games that glorify shooting and death. Of course, the video game marketplace also offers a wide range of non-violent alternatives, including educational or building block games (e.g., The Sims,™ Minecraft,™ Roblox,™ etc.), which are more suitable for children and families. Elimination of gore and mayhem occasionally results in cravings for a certain level of excitement and challenge that is often not present in most non-violent games in the market today. As a result, non-violent games are generally not as popular or as successful.

Improved non-violent video game genres and technologies are desirable that can offer more in terms of adrenaline rush and entertainment. In addition, customizable functionality in video games is needed to satisfy the creative aspirations of the player community.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one or more embodiments, a computer-implemented system for controlling animated renderings on a display device communicatively coupled to a controller device is provided. The system comprises one or more processors for executing logic code causing the one or more processors to perform operations comprising: associating a plurality of animation segments, graphically implemented over a video game platform, to a plurality of corresponding virtual cards in a first virtual deck, a virtual card in the plurality of virtual cards being selectable by a user for animating an avatar displayed on the display device, the avatar being animatable according to movements captured in a corresponding animation segment in the plurality of animation segments included in a virtual card selected by the user; in response to user interaction with one or more input elements on the controller device, animating the avatar according to animation segments in a selected virtual card having a plurality of animation segments; and generating a visual guide providing feedback about synchronization status between animated movements performed by the avatar and a musical beat to which the avatar is animated by the user.

The visual guide comprises one or more user-perceptible elements that allow the user to follow the musical beat and attempt to synchronize timing of the animated movements. The user viewing the one or more user-perceptible elements is able to receive feedback as to when to switch from one virtual card to another. The one or more user-perceptible elements include a status bar with progression markers as movement indicators. The status bar is a vertical or a horizontal GUI ruler interface with the progression markers being presented as projections in the GUI rule. Position of the progression markers corresponds to the musical beat or when the musical beat changes.

In one embodiment, in response to a user synchronizing the timing of the animated movements with the musical beat within a predetermined threshold, the user receives at least one award. The at least one award is accumulated as hype or adrenalin measurable or collectable by the user. The accumulated hype or adrenaline is manifested as at least one of a visual halo or an aura around the avatar, or in form of audio or haptic feedback. The manifestation of the hype or adrenaline assumes an increased intensity as the accumulated hype or adrenaline increases. When the intensity of the accumulated hype or adrenaline reaches a first threshold, the user may earn additional rewards or an ability to cause the avatar to perform one or more special movements. When the intensity of the accumulated hype or adrenaline reaches a first threshold, a visually intensified projection is generated around the avatar as the avatar movements are graphically displayed representing intensified energy. In some embodiment, the accumulated hype or adrenaline is manifested by a shift in color or color intensity in the avatar's environment. The avatar's environment includes at least one or more of a crowed, a figure, an object, a sculpture, or an area of a dance stage in which the avatar is being animated.

A computer-implemented system for controlling animated renderings on a display device communicatively coupled to a controller device is also provided. The system comprises one or more processors for executing logic code causing the one or more processors to perform operations comprising: associating a plurality of animation segments, graphically implemented over a video game platform, to a plurality of corresponding virtual cards in a first virtual deck, a virtual card in the plurality of virtual cards being selectable by a user for animating an avatar displayed on the display device, the avatar being animatable according to movements captured in a corresponding animation segment in the plurality of animation segments included in a virtual card selected by the user; in response to user interaction with one or more input elements on the controller device, animating the avatar according to animation segments in a selected virtual card having a plurality of animation segments; and awarding the user, in response to the user causing the avatar to be animated in accordance with feedback provided by one or more members of an audience viewing the avatar's performance. In some embodiments, the feedback comprises at least one or more of a requested costume worn by the avatar, an audience gesture, a request avatar animation, or other acts that are requested by one or more members of the audience.

A computer-implemented system for controlling animated renderings on a display device communicatively coupled to a controller device is provided. The system comprises one or more processors for executing logic code causing the one or more processors to perform operations comprising: associating a plurality of animation segments, graphically implemented over a video game platform, to a plurality of corresponding virtual cards in a first virtual deck, a virtual card in the plurality of virtual cards being selectable by a user for animating an avatar displayed on the display device, the avatar being animatable according to movements captured in a corresponding animation segment in the plurality of animation segments included in a virtual card selected by the user; in response to user interaction with one or more input elements on the controller device, animating the avatar according to animation segments in a selected virtual card having a plurality of animation segments; and providing feedback to the user, the feedback comprising one or more of an audio feedback, a visual feedback, a haptic feedback, or a performance metric. The visual feedback comprises color changes in the avatar's environment, a color indicating an expected mood associated with at least one type of animation segment. A plurality of colors are associated with a plurality of moods, a first color from among the plurality of colors corresponding to a first mood from among the plurality of moods. A plurality of virtual cards are associated with the plurality of colors, a first color from among the plurality of colors corresponding to a first virtual card from among the plurality of virtual cards.

In accordance with some implementations of the disclosed subject matter choreographed avatar movement and control methods and systems are disclosed. The method comprising associating M1 animation segments, for animating an avatar, to M1 corresponding virtual cards in a first virtual deck virtually implemented over a video game platform; associating M2 animation segments, for animating the avatar, to M2 corresponding virtual cards in a second virtual deck virtually implemented over the video game platform; and providing N virtual decks for selection, the N virtual decks comprising the first virtual deck and the second virtual deck. Transitioning between virtual cards in one or more virtual decks, wherein the transitioning results in rendering of one or more animation segments associated with selected virtual cards as applied to the avatar, such that timing of the transitioning in synchronization with audio being played during the transitioning is a factor in determining a score for the avatar being animated.

In certain embodiments, a computer-implemented system and method is configured for associating five animation segments, for animating an avatar, to five corresponding virtual cards in a first virtual deck virtually implemented over a video game platform; associating five animation segments, for animating the avatar, to five corresponding virtual cards in a second virtual deck virtually implemented over the video game platform; providing four virtual decks for selection, the four virtual decks comprising the first virtual deck, the second virtual deck, a third virtual deck, and a fourth virtual deck. In response to a first user interaction with a first primary input element, a first virtual card in the first virtual deck is selected. In response to a second user interaction with a first secondary input element, a second virtual card in the first virtual deck is selected. In response to a third user interaction with a second primary input element, a first virtual card in the second virtual deck is selected; and in response to a fourth user interaction with the first secondary input element, a second virtual card in the second virtual deck is selected. The method may further comprise transitioning between virtual cards in one or more virtual decks. The transitioning results in rendering of one or more animation segments associated with selected virtual cards as applied to the avatar.

In one aspect, a computer-implemented system for controlling animated renderings via a physical display device is provided. The system comprises one or more processors for executing logic code causing the one or more processors to perform operations comprising associating M1 animation segments, for animating an avatar, to M1 corresponding virtual cards in a first virtual deck virtually implemented over a video game platform; associating M2 animation segments, for animating the avatar, to M2 corresponding virtual cards in a second virtual deck virtually implemented over the video game platform; providing N virtual decks for selection, the N virtual decks comprising the first virtual deck and the second virtual deck. In response to a first single user interaction with a first primary input element on a controller device, a first virtual card in the first virtual deck is selected. In response to a second single user interaction with a first secondary input element on the controller device, a second virtual card in the first virtual deck is selected. In response to a third single user interaction with a second primary input element on the controller device, a first virtual card in the second virtual deck is selected. The system may transition between virtual cards in one or more virtual decks. The transitioning results in rendering of one or more animation segments associated with selected virtual cards as applied to the avatar, such that timing of the transitioning in synchronization with audio being played during the transitioning is a factor in determining a score for the avatar being animated in response to the transitioning.

The first primary input element is a first user interface button on the controller device and the second primary input element is a second user interface button on the controller device. The first user interface button is independently engagable from the second user interface button. The secondary input element comprises one or more input elements associated with one or more states. The one or more states includes a neutral state associated with the first virtual card in the first virtual deck. The one or more states includes a directional state associated with the second virtual card in the first virtual deck. The secondary input element comprises a plurality of input elements associated with a plurality of states.

In some embodiments, the input elements include a neutral state input element associated with the first virtual card in the first virtual deck, and at least one directional state input element associated with the second virtual card in the first virtual deck. The secondary input element may be a directional input pad having a plurality of directional input elements and a neutral state input element, the neutral state input element being triggered by default when the first primary input element is active, thereby rendering a first animation segment as applied to the avatar without user interaction with any secondary input element. The secondary input element may be a directional input pad having a plurality of directional input elements and a neutral state input element, the plurality of directional input elements being assigned to at least one or more of an upward direction, a downward direction, a leftward direction, and a rightward direction respectively, at least one of the plurality of directional input elements being triggered in combination with the first primary input element for rendering a first animation segment as applied to the avatar requiring user interaction with both the first primary input element and at least one secondary input element. The animation segments may depict one or more segments from a dance routine choreographed based on timed sequences that are synchronizeable with the beat or cadence of the audio being played during the transitioning.

In one or more embodiments, a computer-implemented system for controlling animated renderings on a display device communicatively coupled to a controller device is provided. The system may include one or more processors for executing logic code causing the one or more processors to perform operations to control an avatar's movement via a controller device (e.g., a GUI on a smart phone or a physical video game controller) and how the user can move quickly between various virtual dance cards). The operations may include associating a plurality of animation segments, graphically implemented over a video game platform, to a plurality of corresponding virtual cards in a first virtual deck, a virtual card in the plurality of virtual cards being selectable by a user for animating an avatar displayed on the display device, the avatar being animatable according to movements captured in a corresponding animation segment in the plurality of animation segments included in a virtual card selected by the user.

In response to a first single user interaction with a first primary input element on the controller device, a first virtual card in the first virtual deck may be selected. In response to a second single user interaction with a first secondary input element on the controller device, a second virtual card in the first virtual deck may be selected. In response to a third single user interaction with a second primary input element on the controller device, a first virtual card in a second virtual deck may be selected. The avatar may be animated according to animation segments in a selected virtual card, the animations starting from beginning of a first animation segment in the selected virtual card and ending in a tail portion or end of at least one of the first animation segment in the selected virtual card, or a second animation segment in the selected virtual card, the virtual card having a plurality of animation segments, and the second animation segment following the first animation segment.

In response to a fourth single user interaction with an input element on the controller device, the avatar animation is skipped from the beginning of the first animation segment to a wow move, where the avatar jumps into the middle of a choreographed move, instead of starting at the beginning (i.e., the animation jumps to a tail portion of the first animation segment, or a portion of the second animation segment). The selected virtual card may include N animated segments S1 through Sn with respective entry points at times T1 through Tn. User interaction with a designated input element on the controller device results in the avatar being animated according to preprogramed graphical features included in an animation segment from among segments S1 through Sn. The user is enabled to select one of the animation segments S1 through Sn instantly by interacting with the designated input element.

In some embodiments, in response to the user's interaction with the designated input element, the avatar's animation according to a first (current) animation segment ends, and a second (new) animation segment associated with the designated input element is started. Animation segments S1 through Sn may have a first time length. Alternatively, not all animation segments S1 through Sn may have a first time length. Transitioning between two or more virtual cards may result in rendering of one or more animation segments associated with selected virtual cards as applied to the avatar. Timing of the transitioning may be determined to be in-synch or out-of-synch with audio being played during the transitioning such that the scoring mechanism awards points when a transition is in synch and points are not awarded (or are deducted) when the transition is out of synch with the music's cadence. In other words, a score for the avatar being animated is enhanced, in response to the transitioning being in-synch and a score for the avatar being animated is muted or diminished, in response to the transitioning being out-of-synch.

In certain aspects, the in-synch or out-of-synch status of the transition is determined based on a threshold value associated with timing of the transitioning as related to cadence of the audio being played during the transitioning. A score for the avatar being animated is enhanced, in response to the transitioning being in-synch and the score for the avatar being animated is diminished, in response to the transitioning being out-of-synch, the user scoring more points by progressively or repetitively performing a series of predetermined animation moves within a predetermined time threshold. At least one of the input elements is a camera or scanning system configured for receiving input from the user based on the user's movement of one or more body parts. That is, instead of using a controller to control avatar movement, the user performs a dance move that is captured by the camera and translated into an input to the system. The user's body parts are virtually mapped to the avatar's corresponding body parts, such that a user's movement of a first user body part as detected by the camera or the scanning system results in the avatar's movement of a corresponding first avatar body part. At least one of the input elements comprises at least one of an alternate reality (AR) or virtual reality (VR) component configured for receiving input from the user based on the user's movement of one or more body parts. A virtual card or a virtual deck is offered for selection or purchase by the user through an in-game selectable menu or in-game store, or from a digital forum or on-line store.

In one embodiment. the avatar movement as controlled by a controller device (e.g., a GUI on a smart phone or a physical video game controller) such that the user can timely move between various virtual dance cards using a visual guide, such as a bar or marker that tracks the beat of the music being played. To accomplish this, a plurality of animation segments, graphically implemented over a video game platform, are associated with a plurality of corresponding virtual cards in a first virtual deck, a virtual card in the plurality of virtual cards being selectable by a user for animating an avatar displayed on the display device. The avatar is animatable according to movements captured in a corresponding animation segment in the plurality of animation segments included in a virtual card selected by the user.

In response to user interaction with one or more input elements on the controller device, the avatar is animated according to animation segments in a selected virtual card having a plurality of animation segments; and a visual guide is generated providing feedback about synchronization status between animated movements performed by the avatar and a musical beat to which the avatar is animated by the user. The visual guide comprises one or more user-perceptible elements that allow the user to follow the musical beat and attempt to synchronize timing of the animated movements. The user viewing the one or more user-perceptible elements is able to receive feedback as to when to switch from one virtual card to another.

In some embodiments, the one or more user-perceptible elements include a status bar with progression markers as movement indicators. The status bar is a vertical or a horizontal GUI ruler interface with the progression markers being presented as projections in the GUI rule. Position of the progression markers corresponds to the musical beat or when the musical beat changes. In response to a user synchronizing the timing of the animated movements with the musical beat within a predetermined threshold, the user receives at least one award. The at least one award is accumulated as hype or adrenalin measurable or collectable by the user. The accumulated hype or adrenaline is manifested as at least one of a visual halo or an aura around the avatar, or in form of audio or haptic feedback.

The manifestation of the hype or adrenaline assumes an increased intensity as the accumulated hype or adrenaline increases. When the intensity of the accumulated hype or adrenaline reaches a first threshold, the user may earn additional rewards or an ability to cause the avatar to perform one or more special movements, or a visually intensified projection is generated around the avatar as the avatar movements are graphically displayed representing intensified energy. The accumulated hype or adrenaline is manifested by a shift in color or color intensity in the avatar's environment. The avatar's environment may include at least one or more of a crowed, a figure, an object, a sculpture, or an area of a dance stage in which the avatar is being animated.

In certain embodiments, the avatar is animatable according to movements captured in a corresponding animation segment in the plurality of animation segments included in a virtual card selected by the user. In response to user interaction with one or more input elements on the controller device, the avatar is animated according to animation segments in a selected virtual card having a plurality of animation segments and the user is awarded in response to the user causing the avatar to be animated in accordance with feedback provided by one or more members of an audience viewing the avatar's performance. The feedback may comprise at least one or more of a requested costume worn by the avatar, an audience gesture, a request avatar animation, or other acts that are requested by one or more members of the audience.

Depending on implementation, in response to user interaction with one or more input elements on the controller device, the avatar is animated according to animation segments in a selected virtual card having a plurality of animation segments and feedback is provided to the user, the feedback comprising one or more of an audio feedback, a visual feedback, a haptic feedback, or a performance metric. The visual feedback may include color changes in the avatar's environment, a color indicating an expected mood associated with at least one type of animation segment. A plurality of colors are associated with a plurality of moods, a first color from among the plurality of colors corresponding to a first mood from among the plurality of moods. A plurality of virtual cards are associated with the plurality of colors, a first color from among the plurality of colors corresponding to a first virtual card from among the plurality of virtual cards.

Implementations of the current subject matter may include, without limitation, systems and methods consistent with the above methodology and processes, including one or more features and articles that comprise a tangibly embodied machine or computer-readable medium operable to cause one or more machines (e.g., computers, processors, etc.) to result in operations disclosed herein, by way of, for example, logic code or one or more computing programs that cause one or more processors to perform one or more of the disclosed operations or functionalities. The machines may exchange data, commands or other instructions via one or more connections, including but not limited to a connection over a network.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 illustrates an example operating environment, implemented in accordance with one or more embodiments, in which one or more video games may be executed over an off-line or online gaming platform.

FIG. 2 is a representation of example choreographed avatar movements that can be associated with or grouped into an animated set (e.g., a virtual deck including one or more virtual cards), in accordance with one or more embodiments.

FIG. 3 is an example controller utilized for controlling one or more avatars and the transition between different movements, in accordance with one embodiment.

FIG. 4 illustrates a flow diagram for a method of customizing or assigning a set of moves to an avatar, in accordance with one or more embodiments.

FIG. 5 illustrates an example virtual card representing a series of moves, which may be assigned to one or more user interfaces or control instruments of a controller, in accordance with one or more embodiments.

FIGS. 6A and 6B are examples of a combination of user interfaces or control components and instruments that may be mapped to a series of virtual cards to dynamically customized dances for a selected avatar.

FIG. 7 illustrates an example of how interfacing with one or more control instruments transitions an avatar from a primary series of moves (primary virtual card) to one or more secondary series of moves (secondary virtual cards), in accordance with one or more embodiments.

FIG. 8 illustrates an example mapping between certain avatar movements and the corresponding control instruments configured to control transition between different movements, in accordance with one or more embodiments.

FIGS. 9A and 9B illustrates possible example mappings between certain avatar movements and key combinations of a game controller, in accordance with one or more embodiments.

FIGS. 9C, 9D and 9E illustrate possible example graphical user interface controls for switching between multiple virtual cards or virtual decks, in accordance with one or more embodiments.

FIG. 10 is a block diagram of an example computing system's hardware components suitable for execution of logic code implemented to support the gaming software and functional features disclosed herein.

FIGS. 11 through 26 provide examples of graphical user interfaces that may be utilized or adopted in accordance with one or more embodiments to enable a player to interact with, and better understand certain features and aspects of, the game environment as disclosed herein.

FIGS. 27 through 39 provide examples of graphical user interface features that may be implemented to allow one or more users collaborate in creating animated or video content, in accordance with one or more embodiments.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION OF EXAMPLE IMPLEMENTATIONS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

Game Environment

Implementations of the current subject matter may include methods and systems configured for executing or playing a video game on a video game platform or console. In certain aspects, a player (e.g., a user, a consumer, a video game player, a subscriber, etc.) may interact with a video game controller or other machine (e.g., a smart phone, a game console, a general computer, etc.) to select a choreographed series of movements for a virtual character (i.e., an avatar). To accomplish this, the player may choose from a set of predefined moves (e.g., dance moves). These moves may be associated with one or more of a particular dance genre (e.g., hip-hop, breakdance, etc.), popular dance moves (e.g., the Moonwalk, the Floss, etc.), famous people or characters (e.g., John Travolta, He-Man, Brittney Spears, etc.), or popular movies and videos (e.g., Flash Dance, Thriller, etc.).

For the purpose of example, certain aspects of the disclosed subject matter herein are characterized, described, defined or associated with animation moves related to dancing, dance moves, or participation in a dance contest (e.g., a dance battle). It is noteworthy, however, that the functionalities, features and structural elements disclosed herein may be also applicable, with or without some modification, to other forms of virtualizable activity and movement, including but not limited to activities involving any type of sport or any type of move that can be animated or choreographed. Other example embodiments may be applicable to or include moves related to skateboarding, surfing, playing football, soccer, or basketball, or any activity involving tricks using a board or a ball, including but not limited to snowboarding, snow skiing, water skiing, dribbling or shooting. In some aspects, the subject matter may relate to martial arts or a magician performing magic moves or spells for conjuring certain results, for example.

Virtual Cards

In some implementations, and as provided in further detail herein and below, predefined moves may be incorporated into a virtual set of choreographed and animated move segments. A move segment may be visually represented by a series of animations included in a virtual card that can be selected by a player. This implementation of individual move segments into selectable virtual cards enables the player to put together a preferred group of moves by selecting a series of virtual cards that can be combined to animate a selected avatar. Once the virtual cards are assigned to the avatar, the player can select between the different cards in a virtual deck of cards to accordingly control the movements of the avatar.

The player may enter into a staged area in a virtual environment (e.g., a video game representation of a dance stage or some arena or graphically represented space) for the purpose of practicing the moves alone or with a group of other players. In the staged area, the player may be able to select the music, background, skin and various animations incorporated into one or more virtual cards. The player may have or (depending on skill level) be given the option to participate in a contest to compete against other players, either one-on-one or as a participant in a group. By way of choosing between various cards and timely activating the different moves during play, preferably in tune with the rhythm, beat, or cadence of the music being played in the background, a player may control the movements of an avatar by selecting between the predefined moves captured in a virtual card and intuitively transition between the selected moves by way of deterministically switching between the virtual cards in a virtual card deck.

As provided in further detail herein, in certain aspects, the moves are automatically morphed as the selected avatar transitions from one virtual card to another as the player controls the movements of the avatar and performs movement combinations in virtual cards assigned to the avatar. Depending on implementation, a selected avatar may be able to perform all available moves, or all possible moves available in a particular virtual deck assigned to or selected for the avatar, but not any other moves that are not included in the selected virtual deck. Further, a player may not be able to, for some avatars, select, assign, purchase or obtain certain virtual cards. Thus, in some embodiments, an avatar may be either more capable, or possibly less capable of performing some moves, unless certain features or levels are unlocked or purchased by a player so that a desired virtual card can be added to the virtual deck for the particular avatar.

For example, a series of moves may be exclusively available for purchase with a particular avatar or skin. Or, a particular avatar may be able to acquire additional or exclusive moves as the player unlocks more advanced levels using the particular avatar or skin. By way of a non-limiting example, if a player selects a Michael Jackson avatar, that avatar may be compatible with moves in the virtual card for the Moonwalk. A player may be also able to separately acquire other virtual cards, including a card that includes the moves in the Thriller music video, for example, with which the Michael Jackson avatar is also compatible. In contrast, if the player acquires a third virtual card that includes the Floss move, the Michael Jackson avatar may not be compatible with the Floss virtual card and the Floss virtual card cannot be assigned to the Michael Jackson avatar.

It is noteworthy that the above limitations may not be incorporated into certain embodiments, or may be selectively incorporated into one or more embodiments, or may be effective only in association with certain avatars. For example, the player may be able to obtain an avatar (e.g., a Superman or Britney Spears skin) that is configured to be compatible with all virtual cards, or most virtual cards. As such, some avatars may have no limitations, or very few limitations. Conversely, certain avatars may be configured to operate with a limited set of moves, but may include special moves or traits that can throw off a more formidable avatar. For example, a Pee-Wee Herman skin may have a special feature (e.g., a kryptonite tie) that would weaken or limit certain movements of a more capable avatar (e.g., a Superman skin) during a contest. Accordingly, some avatars may have, or may be able to obtain, a secret weapon (or defense) that poses a challenge to (or makes them immune to) certain other avatars.

In some embodiments, a player may competitively play against other players for prizes. For example, depending on skill level or other criteria, players may be matched, scheduled and moved up in an eSports forum in which a plurality of contestants participate to win cash or other prizes. The participants may be randomly matched in certain scenarios or may require to participate in qualifying rounds before being matched.

Artificial Intelligence Scoring Model

In one or more embodiments, a scoring model may be utilized that invokes an artificial intelligence (AI) self-learning model to calculate a score for a player's performance based on the reaction of the audience to the avatar's moves, optionally, in combination with certain other factors. For example, in some embodiments, responses (e.g., “likes” or “dislikes”) submitted by members of a viewing audience who rate the avatar's moves may be measured. In addition or instead, a scoring algorithm may be configured to assign specific scores to a move or a series of moves performed by an avatar (e.g., depending on difficulty).

In certain embodiments, a hybrid approach may be used based on a combination of the audience's reaction and the scoring algorithm to maintain an equitable point system or to avoid cheating. For example, the AI model may prevent a player from being unfairly rated higher (or lower) as a result of unfairly receiving votes (e.g., undeserved “likes” or “dislikes”) from a biased audience, regardless of the player's skills. In other words, unfair votes or outlier scores for a player may be discarded by the AI model in cases where the AI model determines the score is not justified or otherwise in line with an expected score for the particular moves performed by the player.

More specifically, in a scenario where the audience is unfairly “liking” or voting for a player that is not as skilled as another player, the algorithm may detect an outlier event and make a proper correction to the score. For instance, an outlier event may be detected, if a high score is earned by a player in response to the audience voting for a simple move, or a series of simple moves, performed by the player. As such, while the algorithm is configured to reward a player based on the audience's reaction, skill or other factors (e.g., special moves, avatar skin, etc.), the algorithm may also able to detect undeserved high or low scores and block cheating or inappropriate favoritism. In certain embodiments, a member of the audience may be excluded from attendance for inappropriate behavior.

Game Platform

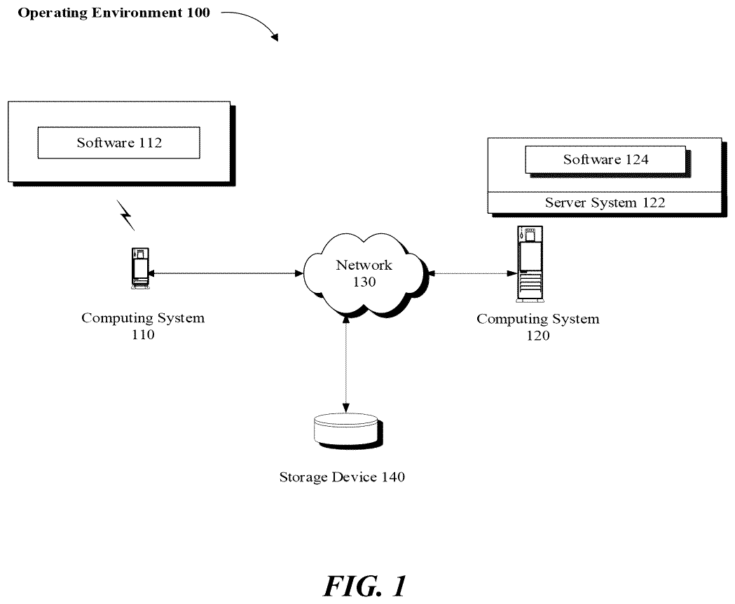

Referring to FIG. 1, an example operating environment 100 (e.g., a game platform) is illustrated in which a computing system 110 may be used by a player to interact with software 112 (e.g., a video game) being executed on computing system 110. The computing system 110 may be a game console, a general purpose computer, a handheld mobile device (e.g., a smart phone), a tablet (e.g., an Apple iPad®), or other communication capable computing device that can be configured or used for playing a video game. Software 112 may be a web browser, a dedicated app or other type of software application running either fully or partially on computing system 110 configured for executing a game or providing a gaming environment.

Computing system 110 may communicate over a network 130 to access data stored on storage device 140 or to access services provided by a computing system 120. Depending on implementation, storage device 140 may be local to, remote to, or embedded in one or more of computing systems 110 or 120. A server system 122 (e.g., an on-line game server) may be configured on computing system 120 to service one or more requests submitted by computing system 110 or software 112 (e.g., client systems) via network 130. Network 130 may be implemented over a local or wide area network (e.g., the Internet).

Computing system 120 and server system 122 may be implemented over a centralized or distributed (e.g., cloud-based) computing environment as dedicated resources or may be configured as virtual machines that define shared processing or storage resources. In certain aspects, the game platform may be implemented over a distributed electronic ledger, such as a blockchain. Execution, implementation or instantiation of software 124, or the related features and components (e.g., software objects), over server system 122 may also define a special purpose machine or computer-implemented mechanism that provides remotely situated client systems, such as computing system 110 or software 112, with access to a variety of data and services as provided below.

In accordance with one or more implementations, the provided services by the special purpose machine or software 124 may include providing a player, using computing system 110 or software 112, with the ability to play a video game such as that disclosed herein. In certain embodiments, the video game may be implemented as software 112 that is either locally supported for execution on computing system 110, or at least partially communicates with computing system 120 and software 124 to provide the player with the capability to play the video game on-line and in connection with a multiplayer environment, such as a massively multiplayer online gaming (MMOG) environment, in which a player may play against, compete, or join forces with other online players.

Microservices Event-Driven Architecture

In certain implementations, a development server may be built using a plurality of microservices deployed in an event-driven computing architecture in which microservices exchange information through the production and consumption of events. An event-driven system enables messages to be ingested into the event-driven ecosystem and then broadcasted to interested microservices. The microservices may be provisioned over multiple servers (e.g., web servers) having cross-dependencies on one another. In some embodiments, a microservice manages its own state so that it can run independent of other microservices. In order to communicate a change in state, a microservice may publish an event, if the microservice updates data that is shared or used by other microservices.

As such, a microservice is given the option to subscribe to events published by other microservices in order to receive notices about data updates and accordingly update related data or functionality. In some aspects, data updates at the microservice level are performed without respect to audio streaming but in respect to time and game design data. Audio data may be used to generate a part of the game design data but audio play back on the server may not be needed. This approach can help reduce overhead and costs by decoupling the components of an application which allows for a better and more efficient scale, independence across the network, and flexibility with respect to computing resources. For example, a small subset of resources rather than all resources may be loaded using the above approach allowing for easier and less frequent updates.

Avatar Control & Choreography

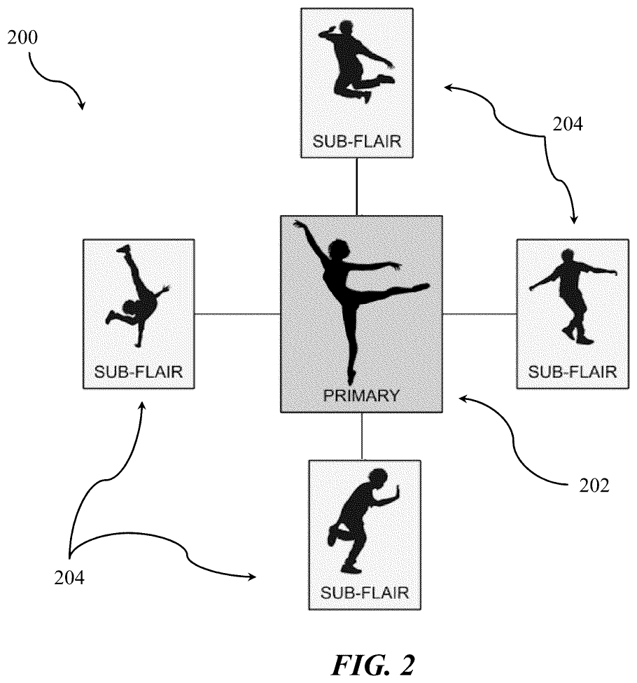

Referring to both FIGS. 1 and 2, software 112 or software 124 may be configured to implement a control mechanism where choreographed moves or animations are divided into animation segments (e.g., virtual cards) that can be associated or chained together to create a custom choreographed move (e.g., a virtual deck) for animating an avatar. A player may be able to execute the animation segments in a dynamically controllable fashion and order to perform a series of moves starting with the movements captured in a primary virtual card 202, for example, and transitioning to selectable secondary virtual cards 204. The player may transition between virtual cards by way of interacting with a user interface component of computing system 110, which provide the player with the freedom to manipulate the movements of a selected avatar in an intuitive but precise and controllable manner with proper cadence.

Referring to FIG. 2, examples of choreographed avatar movements represented in the form of virtual cards are illustrated. As shown, a movement or a series of moves may be associated with a virtual card (or a virtual deck of virtual cards) representing an animated set of movements for an avatar. For example, a deck of virtual cards 200 may include multiple virtual cards including, for example, a primary virtual card 202 (i.e., a flair) and multiple secondary virtual cards 204 (i.e., sub-flairs). The primary virtual card 202 may be associated with one or more secondary virtual cards 204 in a hierarchical arrangement such that a player may transition from the primary virtual card 202 to one of a plurality of secondary virtual cards 204 with a single interaction (e.g., pressing a single directional button) or a relatively minimal number of interactions.

It is noteworthy that the illustration in FIG. 2 is by way of example. In certain embodiments, more than one primary virtual card may be in a virtual deck 200 and any number of secondary virtual cards 204 (e.g., 0 to N) may be associated with the primary virtual card 202. Further, the associations between the individual virtual cards may be single- or multi-layered. In a single-layered arrangement, the virtual cards may be associated in a one dimensional series. In a multi-layered arrangement, a hierarchical structure (e.g., a B-tree, or other multilevel data structure) may be used to implement the relationship between multiple virtual cards. Implementing more levels of hierarchy may make the game more challenging but would provide additional player options and the ability to perform complex moves.

For example, in some embodiments, the virtual deck 200 may comprise a set of standard virtual cards connected in an ordered series (or in an arbitrary order). In such an embodiment, a player may have only one or two options for transitioning from a selected virtual card to the next card. In some other embodiments, instead of having a two-level hierarchical structure such as that shown in FIG. 2, a three-level or multi-level hierarchical structure may be implemented. In such embodiments, a player may have the option of transitioning through multiple layers of virtual cards. Further, as noted earlier, instead of having four secondary virtual cards 204, six (or more) secondary virtual cards may be provided, depending on how the mapping between the virtual cards and the user interface components is implemented.

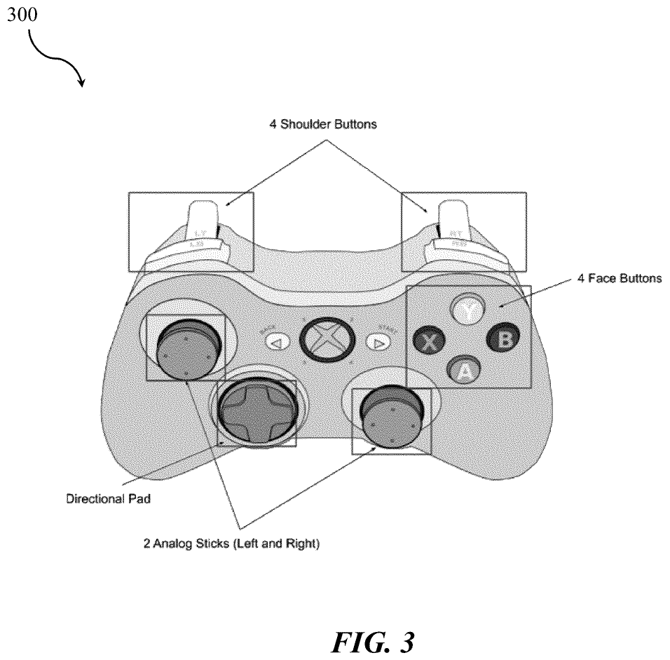

Regardless of the level of hierarchy or the number of primary or non-primary virtual cards in a virtual deck 200, or corresponding mappings between controller buttons and virtual cards, the system may be implemented so that a player can cause an avatar transition from one virtual card or a series of movements to another by way of interacting with one or more user interface components of computing system 110. A user interface component may be a game controller 300, such as that shown in FIG. 3, a keyboard or a keypad (not shown), or a virtualized game controller visually displayable on a screen, which may be controllable via touch on a touch screen or a touchpad (not shown), or a combination thereof.

As such, animation segments for moves, which are assigned to a set of virtual cards in a virtual deck 200, provide a player with the option of controlling a series of moves for a selected avatar. Advantageously, the series of movements are configured such that a player may intuitively control transitioning between different movements in the animated set for a selected avatar. By way of a non-limiting example, various options and scenarios for implementing control over an avatar movements and possible transitions between moves is provided in further detail herein and below with reference to control components and instruments on an example game controller 300.

Control Interfaces

Referring to FIG. 3, an example game controller 300 may include a plurality of control instruments such as one or more buttons (e.g., four face buttons, four shoulder buttons) and directional pads and joysticks (e.g., two analog sticks) that may be utilized by a player for controlling an avatar's movements and the transitions between different movements. In accordance with one example embodiment, a primary virtual card 202 may be associated with a default animation segment that will animate a selected avatar when the controller's instruments or control components are in a first state. The first state may be a default or neutral state, for example, defined by the player holding one of the controller buttons when a directional pad (or a joystick or a series of direction buttons or keys) is in a neutral position. Depending on implementation, movement to a secondary virtual card 204 may be accomplished by way of the player interacting with a directional key on the directional pad to choose a direction (e.g., Up, Down, Left, Right).

Virtual alternatives or equivalents to a physical game controller 300 such as GUI buttons or joy sticks rendered on a touchscreen, or alternate reality (AR) or virtual reality (VR) environments, are also possible and are within the scope of this disclosure. It is noteworthy that in certain embodiments, one or more components or instruments of the game controller may be embedded or displayed onto a display screen (or AR/VR goggles or glasses) on which the virtual game environment is visually rendered. In other words, portions of the display screen may be assigned to interactive virtual control instruments that would function in the same or similar manner to the physical control instruments noted above with respect to the game controller 300.

Depending on implementation, in one or more implementations, the buttons may be virtual GUI buttons on which a player can tap using fingers on one or both hands or a virtual wand. Similarly, the player may control a virtual GUI joystick using one or more fingers, a virtual controller, etc. The joystick may be also implemented on the screen with functional features that would allow a player to drag the virtual joystick in multiple directions to switch between virtual cards or otherwise manipulate the avatar movements.

In certain embodiments, instead or in addition to the physical and virtual interfaces mentioned above, a scanning system or camera may be utilized to receive input from a player based on a player's movement of his body parts (e.g., hand, arms, legs, hips, head, fingers, etc.) and translate such movements into control commands that would allow the player to animate a selected avatar (e.g., according to the captured bodily movements or a video), such that the avatar moves would mimic the players captured bodily movements. The captured bodily movements may be also used as separate commands to select and transition between the various virtual cards.

Avatar Customization & Game Strategy

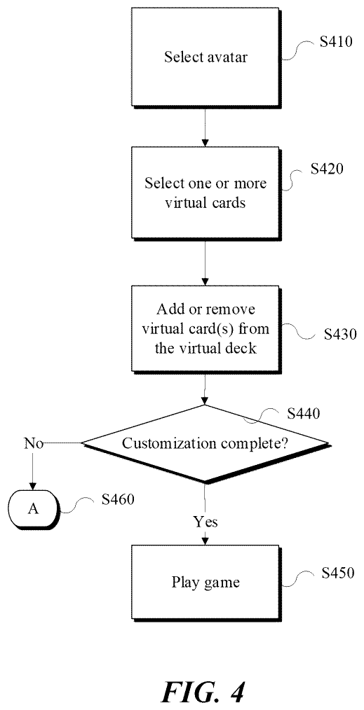

Referring to FIGS. 3 and 4, to play a game, a player may interact with the game controller 300 buttons (or other physical or virtual control instruments) to select an avatar from a plurality of avatar options presented to the player in a selectable graphical user interface menu. The menu options may be implemented in a way that allow the player scroll through the options and view a visual representation of the avatar's skin and optionally functional characteristics (e.g., any virtual cards or virtual decks assigned to that skin). Upon viewing the menu options, a player may select an avatar from the plurality of avatar options (S410). The player is given the option, in some embodiments, to also select one or more virtual cards (or a set of virtual cards implemented in the form of a virtual deck) in association with a selected avatar.

In some implementations, a virtual card or a virtual deck associated with (or available for) the selected avatar is offered for selection or purchase through an in-game selectable menu or store, or from a digital forum or on-line store (e.g., PlayStation Store,™ Apple App Store,™ the Google Play Store,™ etc.). A player may select one or more virtual cards from the provided menu (S420). The selected virtual cards may be either immediately assigned to a chosen avatar, or the player may be given the option to assign one or more virtual cards to an avatar from among a plurality of avatars that are either available to the player or the player may have already in his or her arsenal. In certain aspects, a virtual deck is automatically assigned to an avatar when the avatar is selected. The player may also be given the option to add or remove one or more virtual cards from a virtual deck assigned to an avatar (S430).

In some example embodiments, a virtual deck is limited to a predefined number of virtual cards (e.g., one primary virtual card and four secondary virtual cards as shown in FIG. 2). By adding or removing virtual cards from the move deck assigned to an avatar, a player may customize the avatar's functional capabilities in anticipation of participating in a competition against one or more opponents or participants in a contest. The addition or removal of the virtual cards may be based on player strategy on how to win against a particular opponent or within a certain setting or background. For example, the player may be provided with information about an opponent's avatar characteristics and choose a set of virtual cards for his own avatar to be able to prevail over the opponent's avatar in a competition.

Once the player has selected the virtual cards, as deemed appropriate for the player's purposes, the customization is complete (S440). Then the player may continue to a next stage where the player may start or play a game (S450). As noted in further detail herein, playing a game may involve a practice stage, a contest or competition stage, an editing stage, or other stages in which the player may adjust, control, create or customize movements and features for an avatar. If the customization is not complete, the system may move to an alternate state (S460). The alternate state may include providing a notification or instructions to the player, reporting an error, or looping back to a state in which the player may continue to select an avatar or continue the customization process.

Depending on implementation, if the player decides to enter a practice stage, the player is given the option to learn or practice different moves as the player chooses from among different settings, backgrounds and music options before moving to the competition stage. The competition stage may involve one or more rounds. In an example scenario, there may be three rounds total. The location or setting of the first round may be selected by one or more contestants. For example, a first player may be skilled in dance moves in the hip-hop genre and may select a location, background or setting (including music or audience) that provides the player with the best opportunity to win. In some embodiments, the second round in a competition stage may be selected by a second player that was participating in the first round, for example.

The second player may be given the option to choose a virtual location, background or setting that is most conducive to his style and capabilities for winning the contest in the second round. The third round may be selected by the winner (or the loser) of the second round, for example, if the contestants are tied. Other implementations are possible depending on the nature of the contest and the number of participants in each round. For example, a player may be able to (or be prevented from) switching to a different avatar, or shuffling to different virtual cards, in between rounds or while the game is in progress during a round. Regardless, a goal of a player may be to choose the avatar and a deck of virtual cards that maximize the chances of winning against other contestants according to the contestants' level of skill and the strength or weaknesses of the chosen avatars within a defined competition environment.

Controller-Animation Mapping

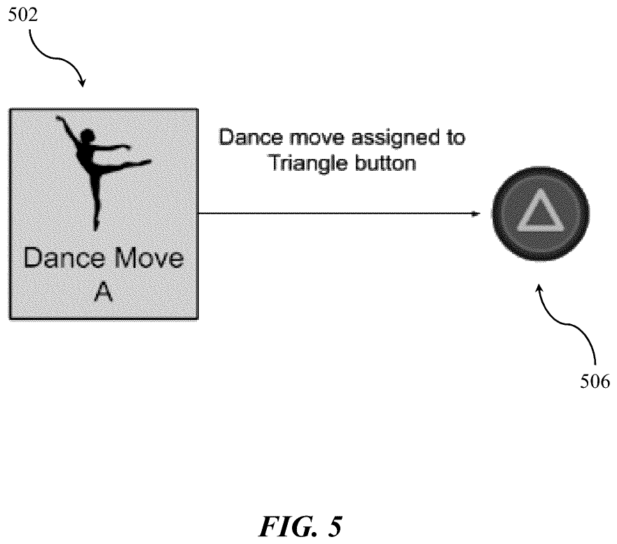

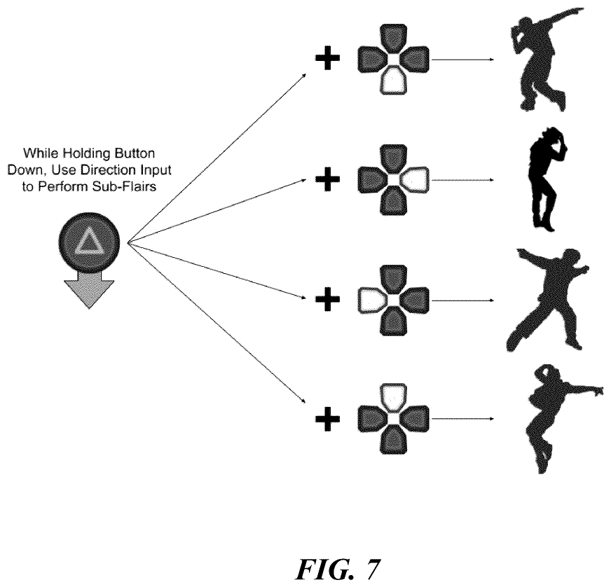

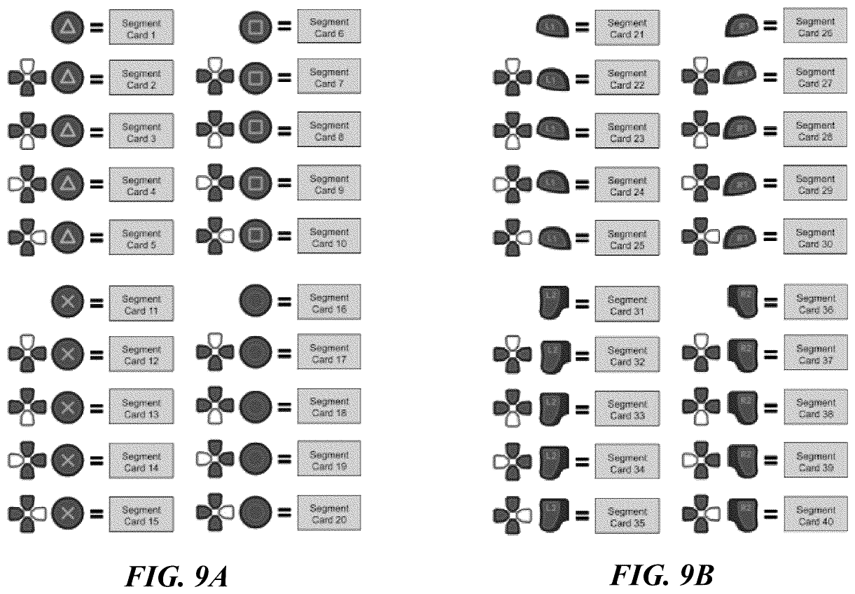

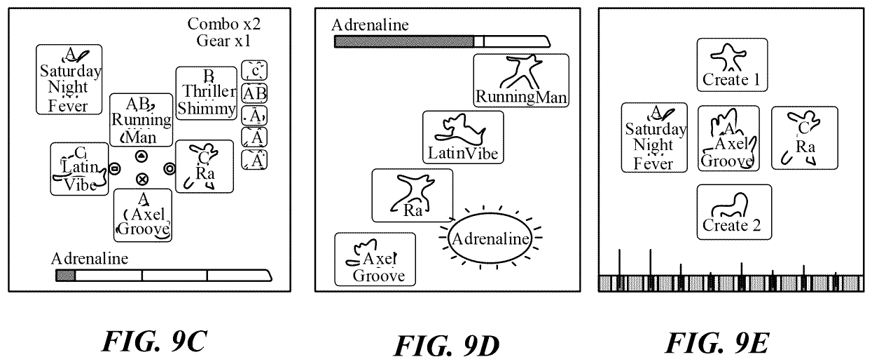

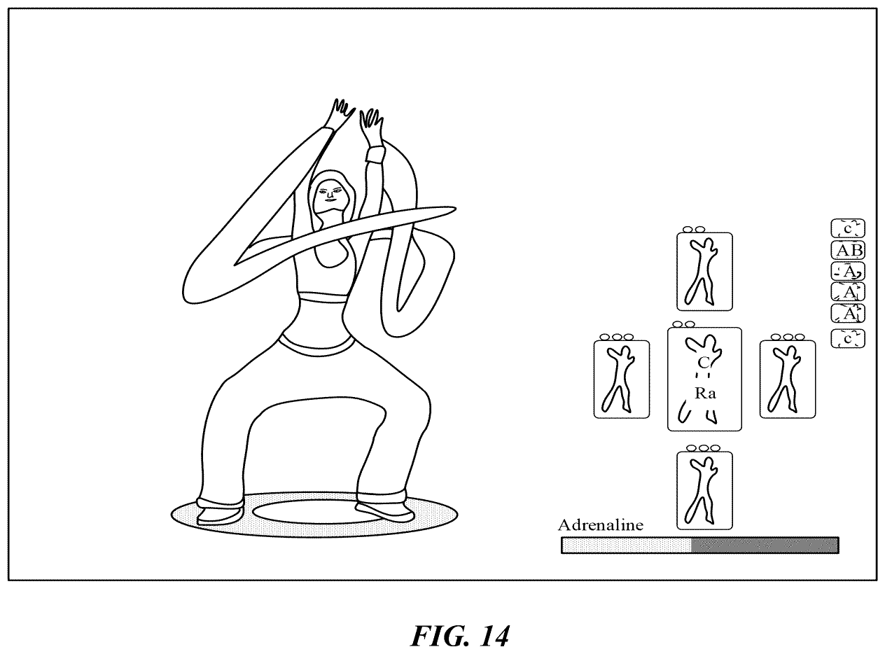

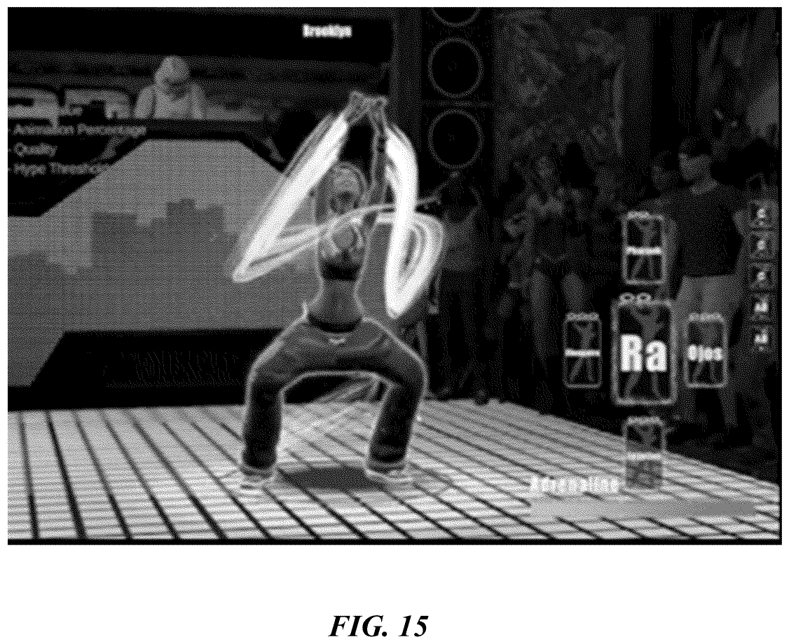

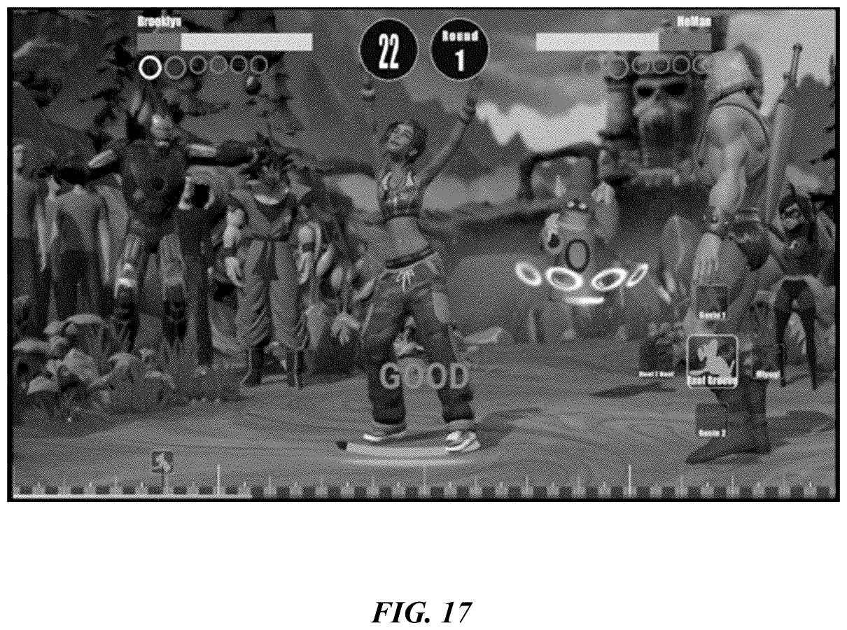

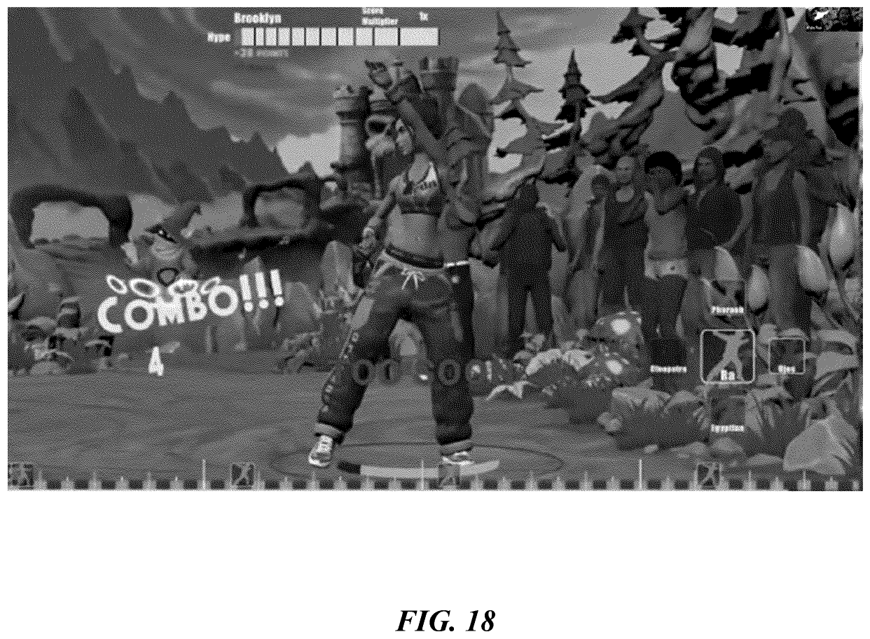

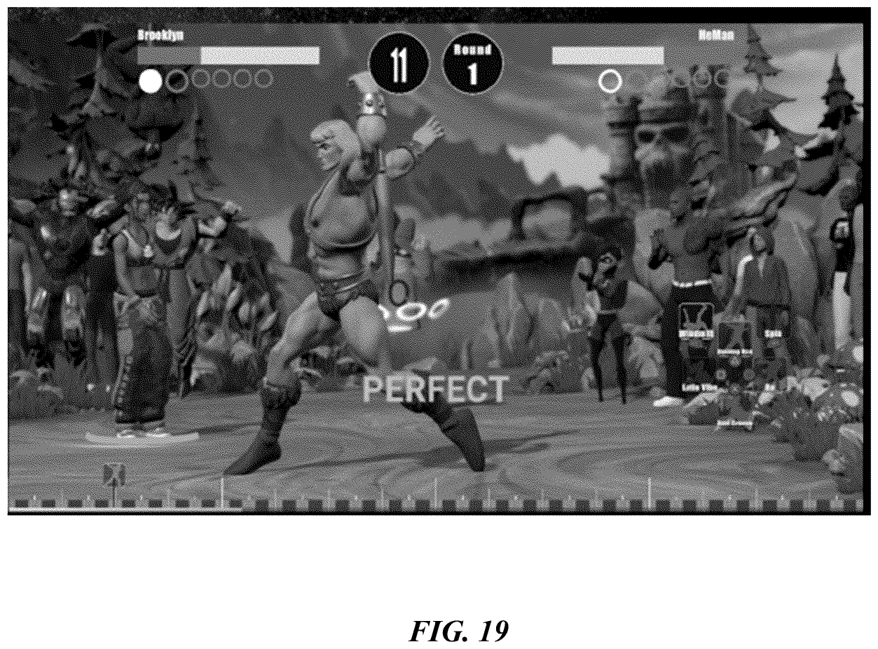

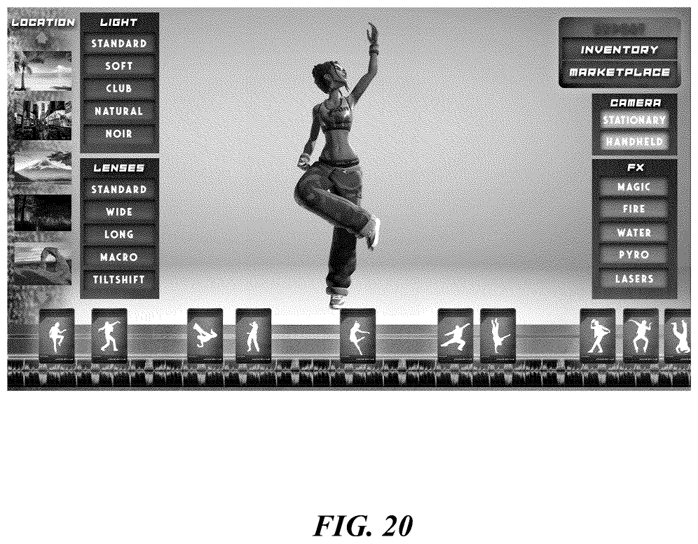

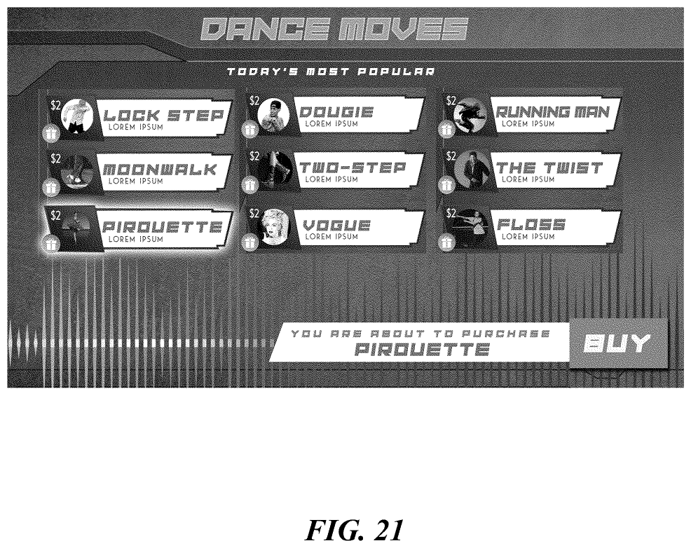

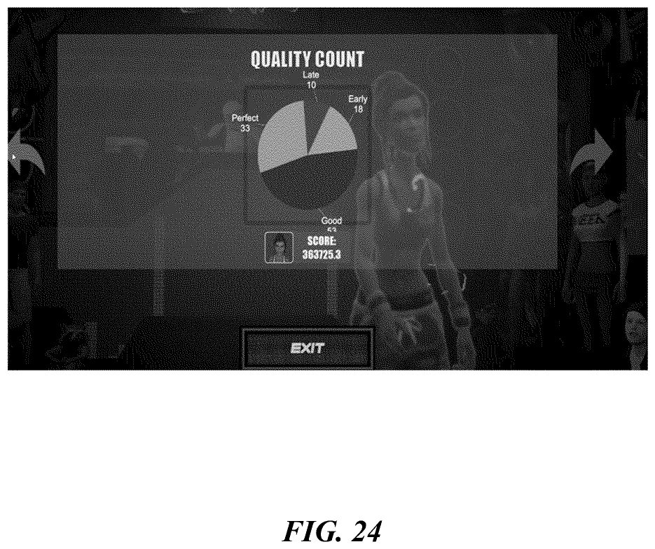

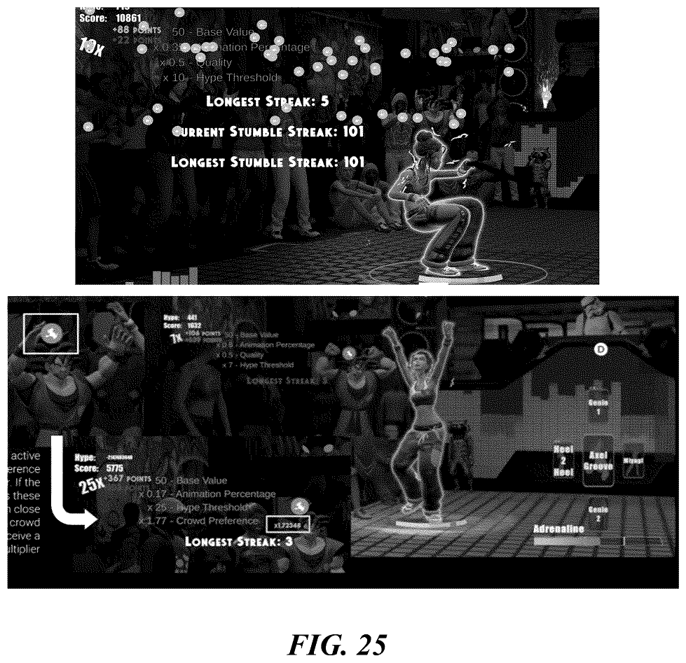

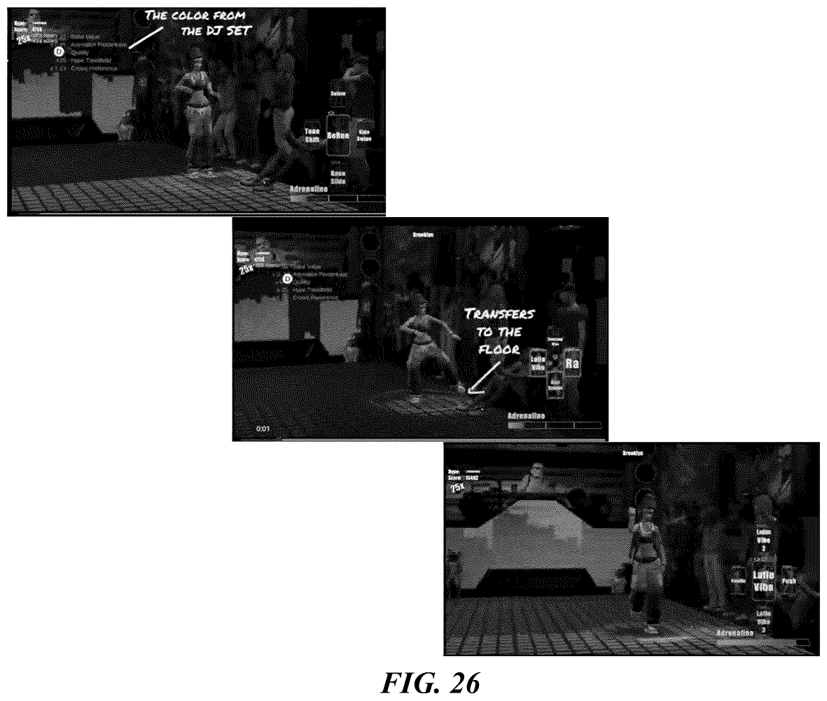

Referring to FIGS. 5 through 8, in certain embodiments, control mechanisms such as a game controller's buttons and joysticks or virtual equivalents on a touch screen (e.g., see FIGS. 9C, 9D, 9E, and 11 through 26) are mapped to certain animations to allow a player to control an avatar's movements and transition between different moves. As provided earlier, the moves may be dynamically assigned to a selected avatar based on a player choosing a set of virtual cards for the selected avatar. Depending on implementation, control instruments such as a joystick component or directional buttons of a game controller (whether physical or virtual) may be configured to correspond to a neutral position or one or more directional positions. For example, a cross-shaped directional map (e.g., see FIG. 7) may be referenced so that the related game controller's user interface components positioning or movements are mapped to five values (Neutral, Up, Down, Left and Right), where each value is associated with a virtual card.

Depending on the number of buttons on the controller, one or more buttons (or a combination of buttons) may be mapped to additional values and thus additional virtual cards (or virtual decks). For example, button combinations on the controller may be configured to select between five virtual cards. In the example of FIG. 5, holding down the triangle button 506 and having the joystick (or directional button selection) in the neutral position may result in the selection of the primary virtual card 502. Referring to FIGS. 5 through 7, by way of holding the designated button 506 down and moving the joystick in up, down, left or right positions (or choosing from the appropriate directional buttons), a player may controllably transition between the other four corresponding secondary virtual cards.

Special & Complex Moves

In certain embodiments, a feature may be provided that allows a user to jump into the middle of a choreographed move represented by a series of virtual cards. For example, a virtual card may be associated with multiple movements (e.g., dance segments) that are X or Y milliseconds long each. By way of a non-limiting illustration, a virtual card may be made up of four segments, for example. The run time of all four segments one after another may be eight milliseconds long, where each segment is two milliseconds in duration. It is noteworthy that not all segments need to be of equal length. For the purpose of illustration and ease of understanding, however, the following examples are provided based on segments that are equal in size.

In one non-limiting example, a two-millisecond segment may be made up of a combination of two movements or dance steps (i.e., the combination of two different animations takes two milliseconds to perform). By holding a special key or using a key combination, a player may be enabled to jump his avatar into a segment's entry point in the virtual card. For example, a virtual card made up of four segments (S1, S2, S3, S4) may have three separate entry points (e.g., at times T2, T3, or T4 corresponding to the timing when animation for S2, S3, and S4 start in the eight-millisecond virtual card). If the segments are allocated an equal amount of time (e.g., if each segment is two milliseconds long) then the player instead of starting with S1 can jump the avatar into 25%, 50% or 75% of an animation movement associated with a virtual card, at timelines T2, T3, or T4 (e.g., 2, 4, or 6 milliseconds into an eight-millisecond virtual card).

In accordance with one or more aspects, the above jump feature may be utilized to allow a player to perform a special move (e.g., a “wow” movement, a “first impression” move, or a “crowed pleaser” move) at a critical moment in time. For example, a player may want to perform a special or favorite move at the start, at the end, or any time during a dance competitions. The player may select a certain button on the controller (or a button combination or other interface feature) and have that button assigned to the favorite move. This special or favorite move can be a selectable segment or one or more steps selected from a virtual card. When the player activates the assigned button, the avatar performs the favorite move by jumping into the exact dance segment or step, all without the player having to select a new dance card, or go through other animated steps or sequences in a selected dance card.

A fixed or dynamic scoring or point system may be used to calculate a score for a player or an avatar selected by the player. The point system may be based on, for example, the complexity of the moves performed, proper timing between the moves (e.g., responsiveness or synchronization with the rhythm of music being played during a game period), or both. A player may be able to score more points, for example, if the avatar can progressively or repetitively perform a series of predetermined moves one after another within a time threshold (e.g., perform a chain of particular moves by selecting two or more virtual cards in sequence that can be linked together). In this manner, a player that can perform a series of predefined moves quickly and flawlessly may be able to obtain bonus points or be provided with bonus features, such as additional health, adrenalin, additional or special virtual cards, or a chance to win extra prizes.

Cadence

In an example embodiment, one objective of the player may be to transition between the virtual cards in sequence with proper timing. That is, the player may be able to score higher points by properly timing the transition between the virtual cards according to the rhythm and beat of the music being played during a performance. The more accurate the timing is, the higher is the score for performing a corresponding move or move segment. In certain implementations, a visual guide (e.g., a scrolling time bar or a rhythm indicator) is displayed to provide the player with feedback about the synchronization between the moves performed by the avatar and the musical beat to which the avatar is dancing. Additional feedback may be provided by suggesting to the player that the transition between the moves was timely or untimely.

Accordingly, in certain embodiments, to assist the player with achieving a better score, interactive or responsive cues are provided as feedback. These cues are user-perceptible and may be audible, visual, or haptic in nature. In one aspect, a graphical user interface (GUI) is provided in which a visual element (e.g., a vertical or a horizontal marker on a ruler type interface or status bar) allows the player to follow the beat of the music and synchronize the timing of the animated movement while the music is being played. For example, the player viewing visual elements (e.g., progression markers) on a status bar is able to receive feedback as to when to switch from one virtual card to another, as a moving indicator moving on the status bar passes each visual element.

One measure of success for gaining a better score may be whether the player manages to switch, for example, from a first virtual card to a second virtual card in a timely manner (e.g., in accordance to the beat or cadence of the music being played). Progression indicators or markers on a status bar may provide clues as to when the proper time has come to switch between virtual cards. For example, a horizontal status bar across an edge (e.g., a lower portion) of the screen may be implemented to include short vertical progression markers such that the position of the markers corresponds to the beat of the music or when the beat changes. See, for example, FIGS. 1-19.

A player that can synchronize the avatar's movements (e.g., switch between virtual cards) precisely at the progression markers would receive points according to a measurement of how precise the moves are timed or synchronized to the progression markers, which in effect represent the rhythm of the music. Accordingly, paying attention to the audible changes in the music being played, in combination with the visual feedback provided by the progression markers on the status bar, allows a player with better cues on when to make a transition between virtual cards and how to score additional points.

Hype or Adrenalin

In addition or instead of points, the player may be rewarded with other special features. One example special feature may be implemented in form of hype or adrenalin and accumulated separately from points. A player attempts to accumulate as much hype as possible before and while dancing. Hype points are awarded for proper contextual selections. For example, selecting the right song and environment for an avatar, or selecting proper contextual dance cards for a predetermined song and environment (e.g., prior to participating in a dance competition or during). Hype, or additional hype, can be also generated when a player properly matches the rhythm or beat of the music while dancing, or when using a combination of moves chained together (e.g., smart combos), or based on audience response, proper cadence, or by meeting other game rules or requirements.

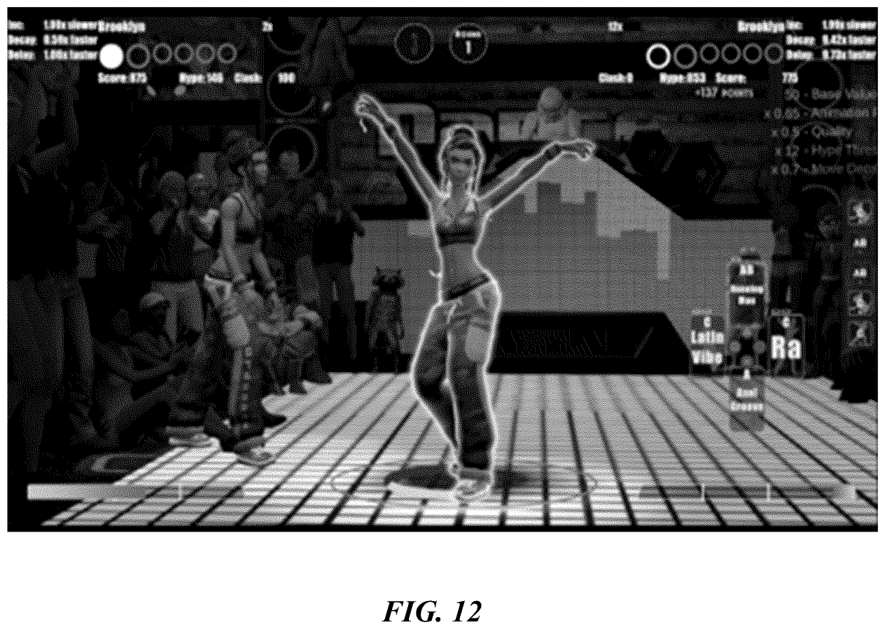

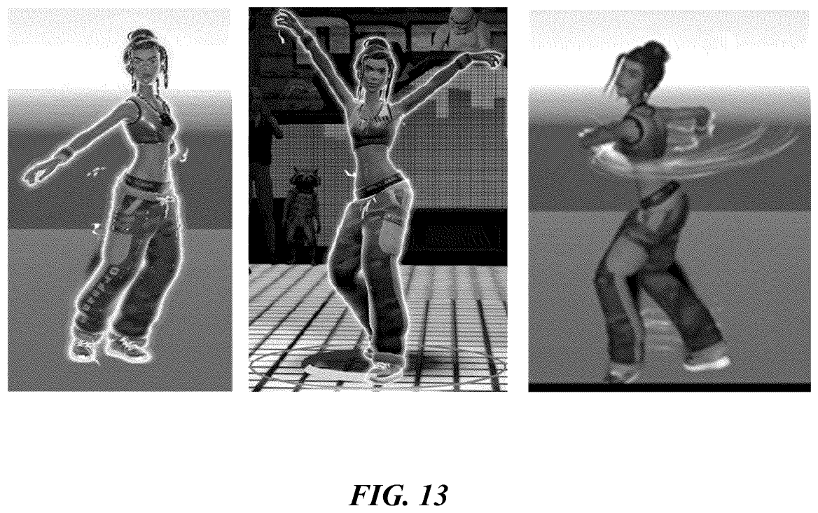

A player may achieve a hype state after accumulating a threshold amount of hype points. In the hype state, a player may be able to perform special dance moves or earn extra points for performing certain moves, or be given other privileges or awards. As hype or adrenaline (or other type of legal or in-game tender) accumulates, the avatar may be able to perform additional moves or receive higher scores for certain moves. In some embodiments, accumulation of adrenalin beyond a certain threshold enhances certain avatar features. For example, adrenaline may be visually manifested as a halo or an aura around the avatar and increase in intensity as the amount of adrenaline collected passes one or more thresholds. See, for example, FIGS. 12 and 13.

Manifestations of hype may be implemented visually (e.g., by showing a glow or aura around the avatar in game environment, turning on surround lighting or a disco ball at the virtual game stage or at a player's real world physical environment, etc.), audibly (e.g., by increasing the music volume, or introducing bells ringing, sound of explosion, etc.), or by way of haptic feedback (introducing vibration in control instruments, or where available by introducing airflow, heat, liquid spray, aroma, etc. in the player's environment). The hype manifestation may be increased as the avatar performs the proper moves or combination of moves.

Possible visual manifestations may include adjustments in lighting, colors, shapes or other features associated with the visual appearance or likeness of the avatar. Some other aspects may include graphically tracing the movements of the avatar's body parts (e.g., a halo or other graphical visualization of energy associated with the avatar's hands, arms, legs, feet, head, face, tongue, etc.) as the avatar engages, performs, completes, or transitions between moves. See, for example, FIG. 13 through 15 showing a highlighted outline of the avatar in a bright color as the player manages to create hype. As shown, flashes of light represented around the avatar that mimic or follow the visual movement of the avatar's hands, legs, head, or body may also indicate a special state or movement having been performed.

Crowd Color Saturation

In some embodiments, a special visual effect is applied to the crowd (e.g., crowd splash) after the avatar accumulates a certain amount of hype, or uses the hype status to perform a special move that is otherwise not available to the avatar outside of the hype state. Depending on scoring, hype features may be implemented based on crowd engagement (e.g., feedback provided by an audience that is actively or passively participating, input from social media feed, etc.). One or more avatars, figures, object, sculptures, or certain areas of the dance stage may change color (e.g., from grayscale to less or more vibrant color), for example by way of a sudden or gradual shift as the player gains additional points, hype, or some other measurable feature or dance effect. Such other measurable features may include encouragement or discouragement by the audience by way of, for example, instant messages, emojis, or the like. Optionally, the color change scheme may apply to one or more members of the attending audience as the player dance moves satisfy, excite, disappoint, or otherwise meet or fail a request by an individual audience member.

Audience Preference

A player may anticipate the audience's preferences (based on available profiles) or receive input from one or more members of the audience about their preference for a song, a dance move, or other feature controllable by the player (e.g., an outfit, a skin, a dance combination, a facial mimic, a hand gesture, etc.). If the player chooses to oblige with a request from the audience or correctly anticipate audience preferences by performing a move, then the player may be rewarded by way of points, or the participating audience may have the option to provide the player with a reward (e.g., by transferring to the Player in-game or external currency).

Some examples for appeasing or pleasing the audience may include the avatar putting on a requested costume, gesturing a hand heart, blowing a kiss, doing a flip, or other acts that are requested by one or more members of the audience and as available in a dance card. The audience may respond in kind with a gesture, or use emoji or text, or special animation such as showering the avatar with cash, gold coins, or other visual effects. The reward may be higher if a larger portion of the audience is pleased or if the player responds before a threshold time period expires, or if the dance move is performed within a threshold vicinity of an audience member or in a special area of the stage. A negative reward (e.g., punishment) may be also implemented, if the player performs a move that displeases a majority or a predetermine group or portion of the audience.

Dynamic Feedback

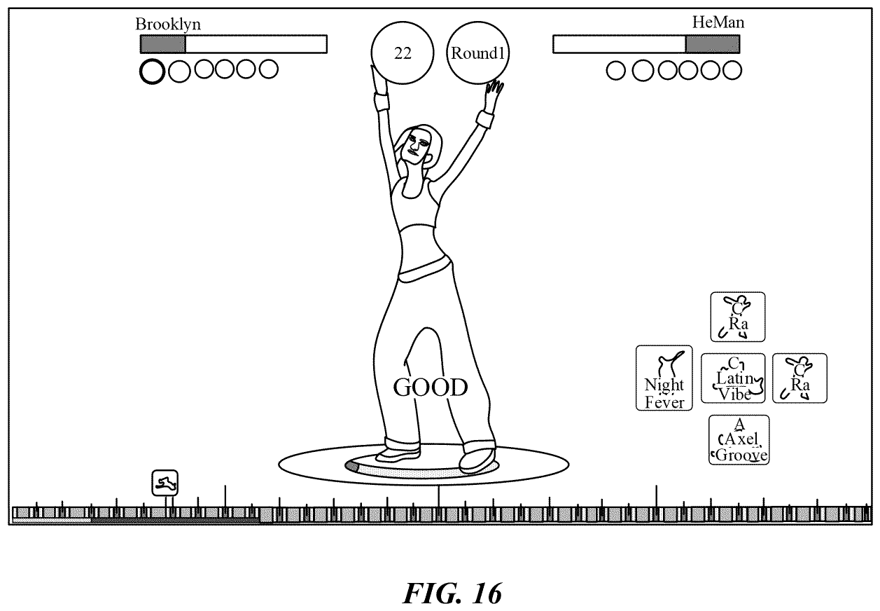

In some embodiments, audio or visual feedback may be accompanied by or include a sound or a popup window, text, or image that indicates how well the player is performing in switching between virtual cards. For example, a pop up may indicate “perfect,” “good,” or “too late” depending on how well the player has synchronized the movements of the avatar to the cadence of music being played. See, for example, FIGS. 16-19.

Notably, instead or in addition to visual feedback, audible, haptic and other types of feedback may be also implemented to assist a player with timely transitions between virtual cards. For example, the dance environment or stage may be implemented to reflect a transitional communicative color scheme, for example, by way of a color stream that will provide the player with an understanding of which moves would be more suitable for the particular environment, stage, music, or audience. Each dance card may be associated with a color. The color stream provides guidance and clues to the player about which type of moves (i.e., as associated with a color assigned to a dance card) will result in a higher scores. The environment color may be tied to the type of music being played or other mood factors.

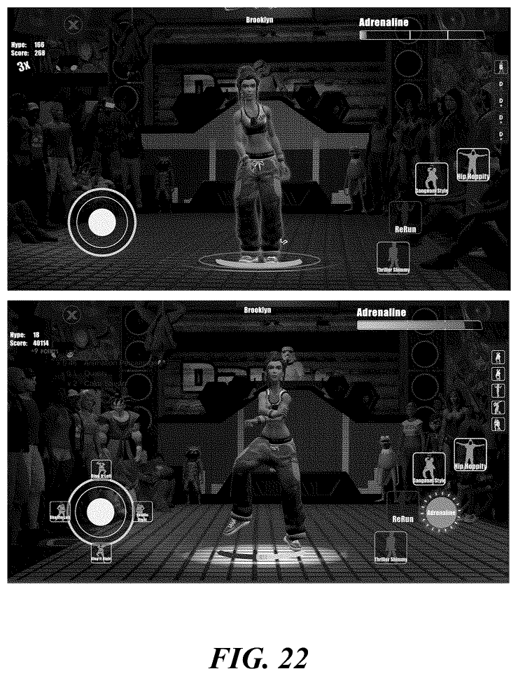

Referring to FIGS. 22 through 23 and 26A, 26B and 26C, for example, a player who selects the dance cards (or the types of dance cards) that best match the mood, tenure, tone, emotional subtext of the music, will score higher against another player that fails to do the same. As shown, the clues for a change in mood during a dance can be provided by way of the color stream as the colors change over time. For example, the color stream may start in blue (a calm tone) and propagate from a first area in the GUI (e.g., the DJ or DJ booth) to a second area (e.g., the dance floor or stage).

If the tone or subtext of the environment or the music starts to change, then a different color such as, for example, red (a fierce tone) may be mixed or added to the flowing color stream, such that the red color starts propagating from the first area to the second area. Other colors or color combinations are possible, without limitation, where a different color, for example, yellow (a joyful tone) alerts or guides the player to change or start thinking about changing the avatar's dance moves to a dance card that matches the indicated mood or color.

If the avatar is dancing in the second area (e.g., a dance floor or stage) that is visually or virtually connected or associated to the first area (e.g., a DJ booth), the player may have a limited amount of time to react. For example, the player may select a new dance card that match the new mood being projected by the color flowing from the first area to the second area. The player will be rewarded (e.g., extra points or hype) by timely reacting and may be punished (e.g., lose points or hype) for an untimely execution. The spot on which the avatar is dancing (e.g., a third area within the second area) may optionally reflect a color that matches the mood or the color of the dance card selected by the player at the time.

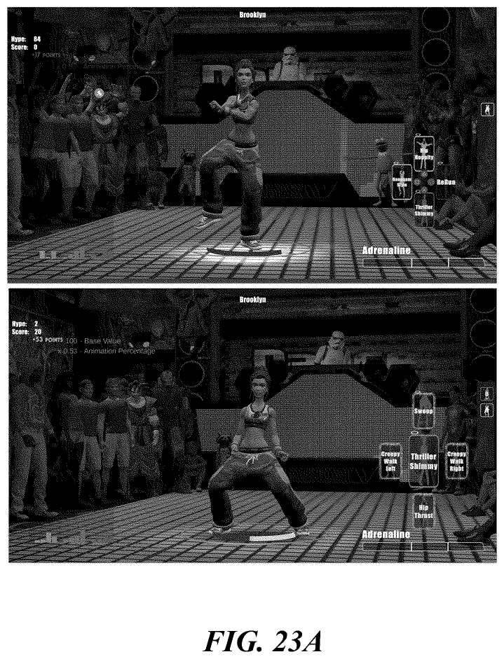

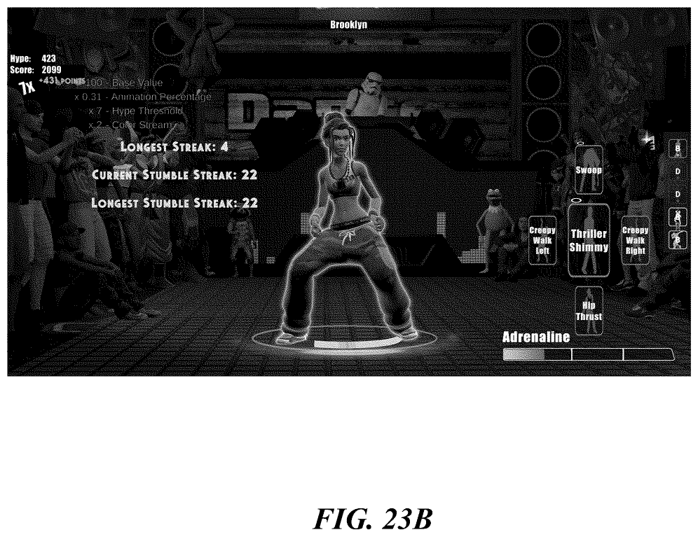

Referring to FIGS. 22, 23A, 23B, the in-game graphical user environment may be implemented to provide additional guides to help a player achieve higher scores or more become fully engage. For example, a scrolling guide may be provided that tracks and visually displays a series of moves performed by the avatar. This visual guide can be implemented to, for example, show the last five distinct dance moves performed (e.g., the five previous dance cards) or a presentation of a number of dance moves performed during a defined period of time (e.g., dance cards used during the last 20 seconds). The visual guide may also show a mood color associated with the series of moves (e.g., dance cards) being performed.

As shown in FIGS. 22, 23A, 23B, a vertical guide is displayed on the right area of the display that lists five moves (e.g., five consecutive dance cards). The visual guide may be implemented to be updated (e.g., in an upward vertical scrolling fashion) so that as new moves are added to the guide (e.g., at the bottom of the visual guide), the older moves are removed from the guide (e.g., from the top of the visual guide).

Referring to FIG. 23B specifically, in some aspects, the list may be designed so that subsequent moves can be linked together (e.g., by way of a visual symbol, such as a chain link), where the link indicates to the player that certain moves were properly (e.g., perfectly) performed to satisfy a condition or threshold set in the game rules for receiving extra points or awards. Such linking accomplishment may thus be rewarded by awarding the player additional points or hype or other rewards (e.g., choice of a skin, outfit, unlocking a new level, etc.).

In certain embodiments, another visual guide may be also implemented that is designed based upon a similar scrolling guide, whereas instead of tracking the moves performed by the avatar in the past, the guide provides the player with a guidance as to which moves (e.g., which dance cards) can be expected in the future. For example, the guide may provide a waterfall of dance cards that suggest in advance that if certain expected moves are performed, the player will receive an award or is awarded higher points.

Midstream Challenge

Players who participate in a contest or battle (e.g., a dance battle) may have the option to play friendly games that simply identify a winner at the end of the contest, which may include one or more rounds. In accordance with some aspects, a player may specifically challenge another player. Optionally, during a competition between a first player and a second player, while the first player's avatar is engaged in the contest (e.g., a first avatar is dancing as controlled by the first player), the second player may invoke a special feature (e.g., a clash, a challenge, etc.) which would allow the second player to temporarily interrupt the first player and challenge the first player to a duel.

In some embodiments, the first player may need to accept the duel in order for the second player to engage and for the duel (e.g., a short clash) to be activated. When a duel is activated or accepted, the first player and the second player will take turns to perform a series of moves that may be specifically scored based on input from a present audience. The player that wins the duel may get extra points that go towards winning the contest, or alternatively may result in damage to the opponent in one or more ways, such as for example a reduction in points or hype or health, etc.

Example Control Interface Features

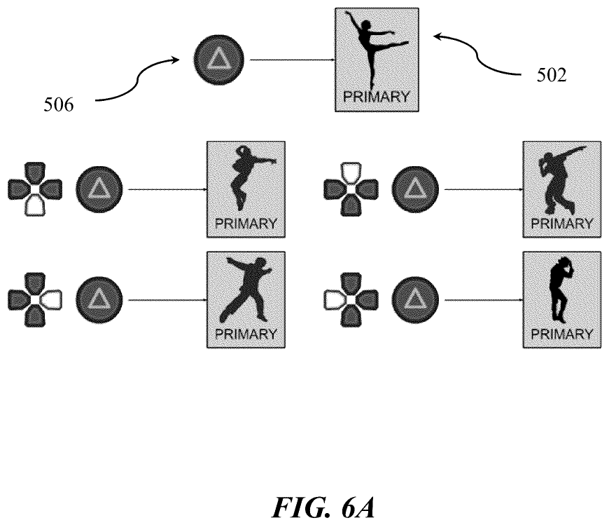

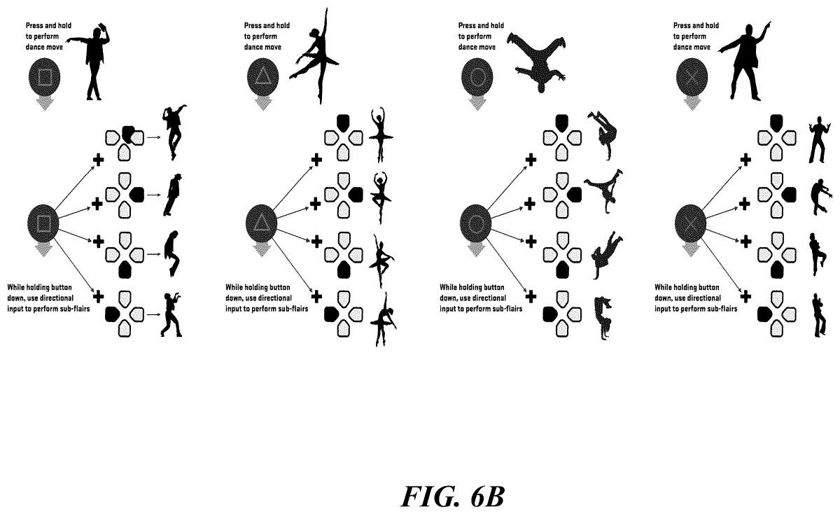

Referring back to FIGS. 6A and 6B, depending on the number of buttons and directional options available on a controller, a player may be able to control transitioning between a number of virtual cards with by pressing a minimum number of buttons. In the example of FIG. 6A, the player may control movements of the avatar by transitioning between five virtual decks, for example, by pressing a primary button (e.g., a triangle button or another designated primary button) one or more times. As shown in FIG. 6A, pressing the triangle button once may select a first virtual deck having a plurality of virtual cards for a first animation genre (e.g., ballet). Pressing the triangle button twice may select a second virtual deck having a plurality of virtual cards for a second movement genre (e.g., modern dance), and so on. As such, a player may cycle through a number of different virtual decks by pressing a designated primary button several times.

As shown in FIG. 6B, the player may interact with four primary buttons (e.g., square, triangle, circle, X) and a number of secondary buttons or user interface components (e.g., directional inputs) to choose from a set of virtual cards in a selected virtual deck. As such, four separate primary buttons may be assigned to four different virtual decks. For example, a first primary button (e.g., the square button) may be assigned to a first virtual deck having a first plurality of virtual cards associated with a first animation genre (e.g., Thriller dance moves), a second primary button (e.g., the triangle button) may be assigned to a second virtual deck having a second plurality of virtual cards associated with a second animation genre (e.g., ballet dance moves), and so on. In this embodiment, a player is enabled to select a virtual deck by pressing a single button once and move through the virtual cards in the virtual deck by selecting from a set of secondary buttons to choose from a set of five virtual card, where four directional secondary buttons (e.g., up, down, right, left) are mapped to four virtual cards, and a neutral state secondary button is mapped to a fifth virtual card.

Referring to FIG. 7, in one aspect, after pressing or while holding a primary button, a player may cycle through, for example, five virtual cards in the selected virtual deck. This allows the player to easily and intuitively move from one virtual card in the virtual deck to another without having to literally lift a finger and by simply manipulating the directional input to seamlessly switch between the virtual cards. In this example, the player can cycle between five virtual cards by interacting with a single primary button and four secondary buttons. Assuming a total number of four primary buttons on a controller, the player can easily transition between (4×5) twenty virtual cards by interacting with a combination of the four primary buttons and four directional inputs corresponding to five states (neutral, up, down, left, and right), where each state is mapped to a virtual card.

It is noteworthy that in at least one example embodiment, after interacting with a primary button (e.g., the triangle button) to select a virtual deck, the player may not need to actively interact with a secondary button (e.g., a directional button) in order to select a virtual card in the chosen virtual deck. In other words, once the virtual deck is selected by interacting with a primary button, a default virtual card mapped to a first state (e.g., a neutral state) may be automatically considered as selected or being active. In the four examples shown in FIG. 6B, the virtual card for the neutral state is shown on top (next to each primary button). The four secondary directional buttons are shown below (next to the directional buttons). In the example of FIG. 7, four virtual cards that correspond to selecting the primary triangle button in combination with down, right, left, and up directional buttons are shown. The fifth (e.g., default) virtual card corresponding to the neutral state is not shown.

As such, in one embodiment, the animation associated with the default virtual card may be used to animate the player's avatar once the player selects the corresponding primary button and the default animation is cycled through in an animated loop until the player interacts with the controller to either (1) move to another virtual card in the selected virtual deck or (2) select another virtual deck. In one embodiment, if the player desires to select another virtual card in the virtual deck, the player may press one of the secondary buttons. If the player desires to select another virtual deck, the player may press one of the primary buttons.

Example Control Interface Animation States & Assignments

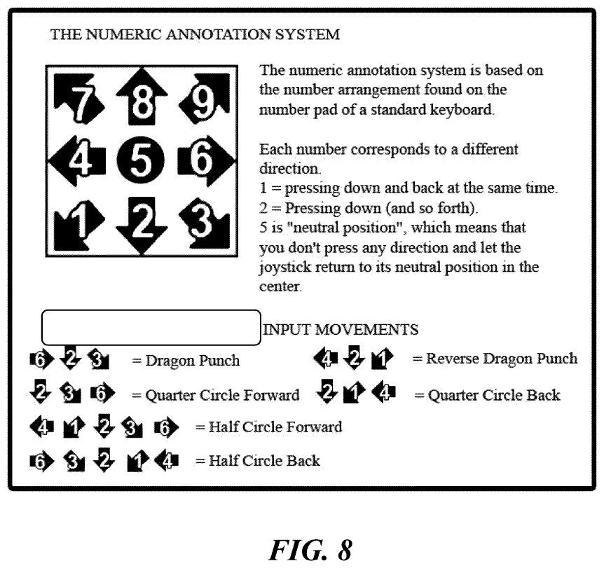

Referring in addition to FIG. 8, if the directional interface component (e.g., a joystick, or a series of directional buttons) is configured to recognize one neutral state (e.g., state 5) and 8 directional states (e.g., 1 through 4 and 6 through 9), then the number of selectable virtual cards per virtual deck (e.g., per primary button) can be increased to nine. Thus, a controller with four primary buttons may be able to select between 36 (4×9) virtual cards and therefore control an avatar into performing 36 different animated moves with at most two player inputs corresponding to the selection of (1) a primary input from a total of four primary input components and (2) a secondary input from a total of nine secondary input states. Thus, where a controller provides N primary input components (e.g., N buttons) and M secondary input components (e.g., M directional states), the player can select M×N virtual cards using a combination of only two inputs.

FIGS. 9A and 9B illustrate more specifically how a player may animate an avatar by choosing between multiple virtual cards mapped to a plurality of button combinations. In this example, eight controller buttons are mapped to eight virtual decks. Each virtual deck provides access to one primary virtual card and four secondary virtual cards by way of the player interacting with a primary controller button and a secondary controller instrument (e.g., a joystick) that has a five-way position factor (Neutral, Up, Down, Left, Right). As shown, a player may simply hold a key combination to which the virtual card is assigned and transition between a total of 40 virtual cards. The avatar, as displayed on the screen, will begin to perform the segment animation assigned to the selected virtual card and loop through that animation until the player releases the key combination or selects another virtual card.

As such, by way of interacting with the control instruments on a controller, a player may have access to any of the eight primary virtual cards in a single interaction and to any of the 32 corresponding secondary virtual cards in at most two interactions. In accordance with certain aspects, transitioning between virtual cards in different segments is smooth and without a break due to combining two or more selected moves, from two separate virtual cards that are being transitioned, to create a third move that is a combination of, but patently different than, the first two moves. Conventional video game technology fails to accommodate such a feature where distinctly programmed avatar moves are combined together to create a third move that is similar to, yet different from, the two moves being combined.

As provided herein and above, in some implementations, combinations of directional inputs and buttons may be configured to initiate a particular action or move animation. In addition to the button combinations, a player performing a particular sequence of moves or the player interacting with a particular series of buttons may result in the avatar performing a special move. Failure to execute the button combination or the sequence correctly may result in the execution of individual actions or animations assigned to the individual buttons. If the player executes a predetermined programmed sequence (or a sequence created by the player) correctly, then a unique action or animation may be executed and the player may be awarded with higher points for such combination execution.

In certain embodiments, in addition to, or instead of, a series of key combinations or move sequences, a player may be able to create a library of moves that can be performed intuitively without any requirements for the player to memorize a specific key combination or sequence. For example, once the player has obtained a certain number of virtual cards, the player may be able to chain selected virtual cards together in a preferred order to create one or more custom moves that can be automatically performed back to back by pressing one or just a few buttons. Advantageously, unlike the conventional games which require a sequence of three or more button presses and joystick interactions for performing a high scoring or impressive move, the player may simply customize a small combination of buttons to access a large number of moves from either a default or customized library of animation segments that include custom virtual decks made up of virtual cards specifically selected by the player.

Customization and Video Editing

In certain embodiments, in addition to creating custom virtual decks, a player may be able to also create custom virtual cards. Each virtual card may include a series of micro-moves or micro-segments. A player may be given access to a library of micro-moves, for example, with the option to combine a plurality of the micro-moves to create a macro-move or macro-segment, where a macro-segment is configured into a virtual card. In other words, in certain implementations, a player may be able to select a very fine avatar movement referred to herein as a micro-move, where the micro-move defines an atomic move associated with a specific body part (e.g., the avatar's head, hip, shoulder, hand, or foot). Two or more of the micro-moves may be combined to create more complex macro-moves as specifically designed by the player. One or more newly created macro-moves may then be stored as a virtual card and saved into a virtual card library. Alternatively, the player may be given the option to edit pre-designed macro-moves in a virtual card by adding or removing certain micro-moves from a virtual card.

Accordingly, in certain embodiments, the player may be able to interact with a virtual card editor module to create a modified or completely new virtual card with new or different move segments. The editor module may provide a variety of editing features. One feature may allow the player to select one or more virtual cards and automatically pick and combine random micro-moves from the selected virtual cards to create a new virtual card. For example, a player may select a Moonwalk virtual card and a virtual card including the Floss and ask the editor to randomly mix macro-moves from those two virtual cards to create a new virtual card. In this manner, it is possible for a player to easily create an infinite number of unique virtual cards without substantial effort. As such, a player in addition to playing the game as a contestant may also participate as a creative agent and optionally offer his or her creative work in form of virtual cards for sale in a digital market place.

In accordance with certain embodiments, in-game purchases, including the purchase of virtual cards or virtual decks may be enabled by the virtue of an in-game phantom currency. In certain aspects, a crypto currency may be implemented or adopted to allow players to make transactions both inside and outside the game environment. Certain embodiments may allow a player to upload dances into the game environment by way of, for example, capturing a video or images of an actual performance, where the uploaded video or images may be converted into one or more virtual cards for the purpose of use within the game environment. A conversion mechanism may be utilized that scans the uploaded images and video. Using artificial intelligence, the system may determine the best poses or image frames to be captured for the purpose conversion to virtual cards. The generated virtual cards may be then grouped into one or more virtual decks for use or sale.

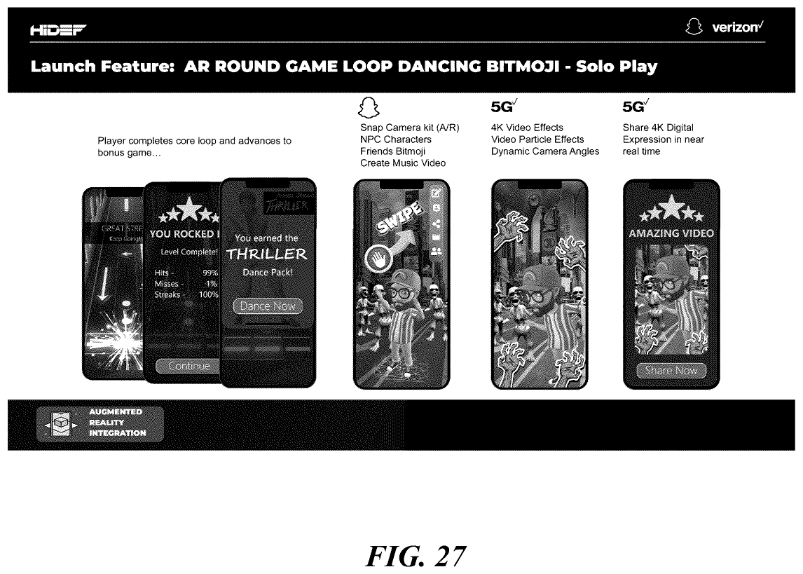

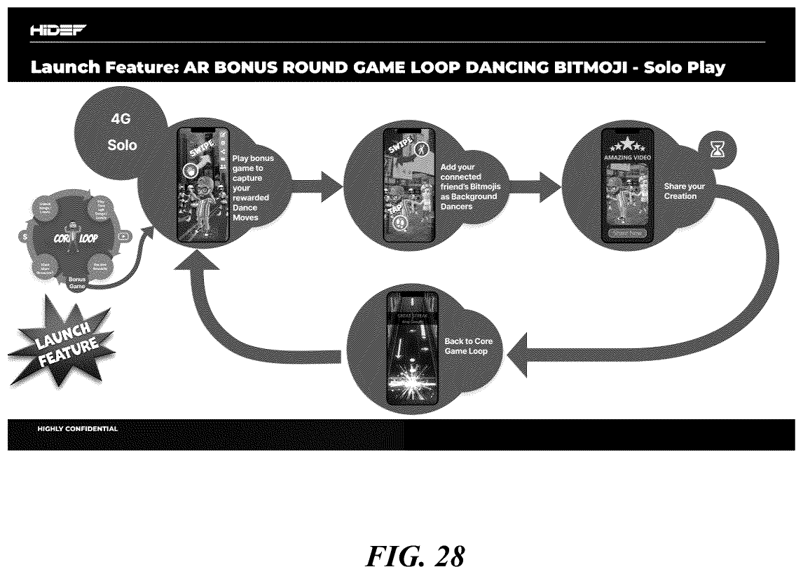

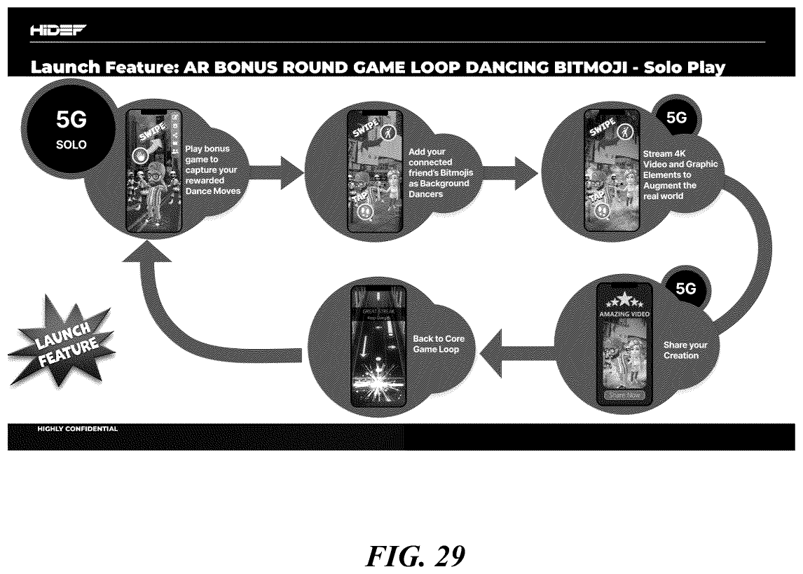

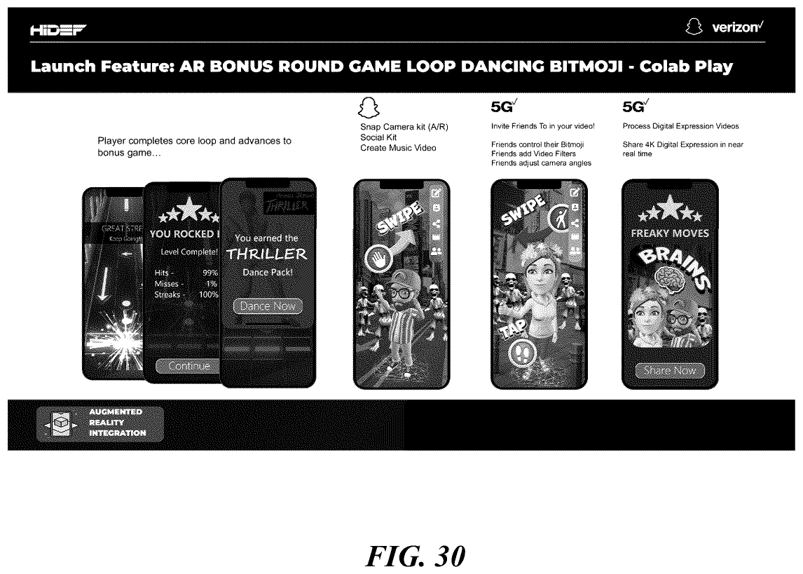

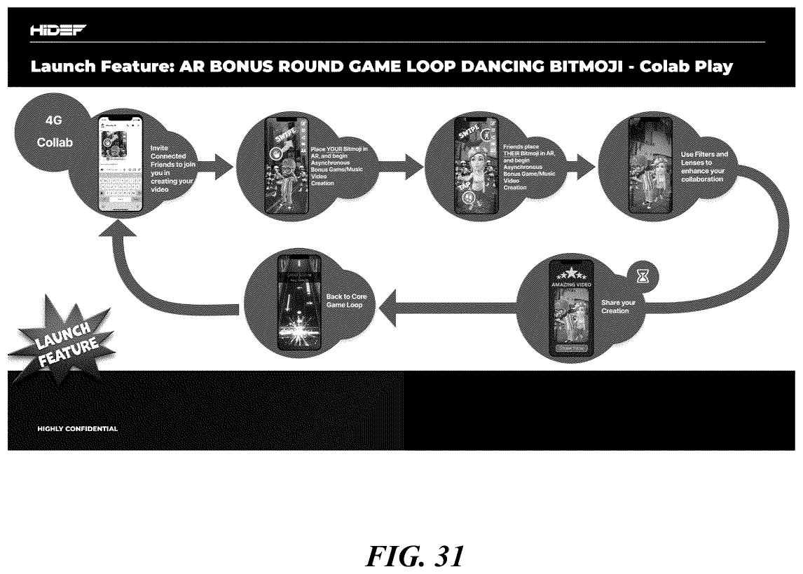

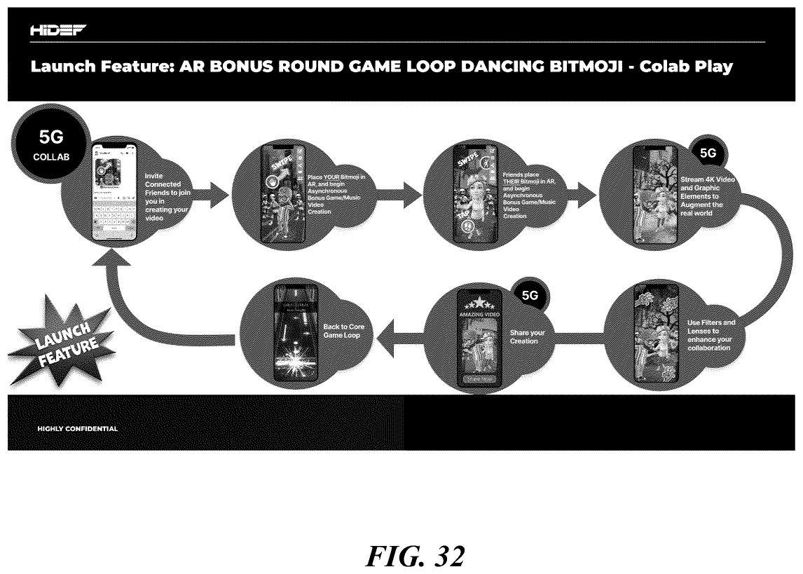

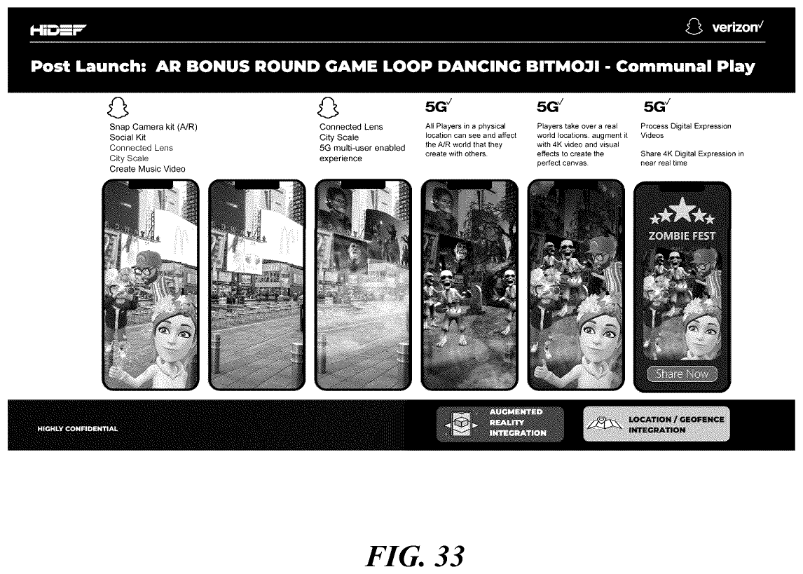

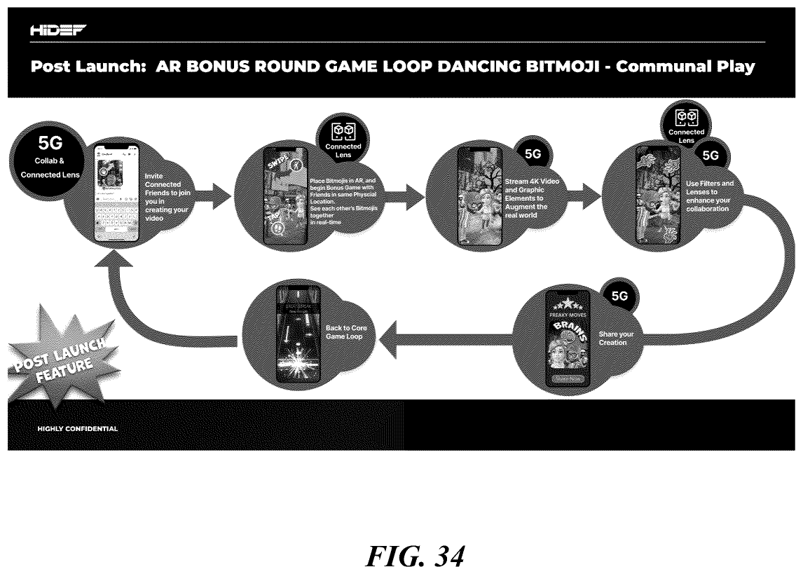

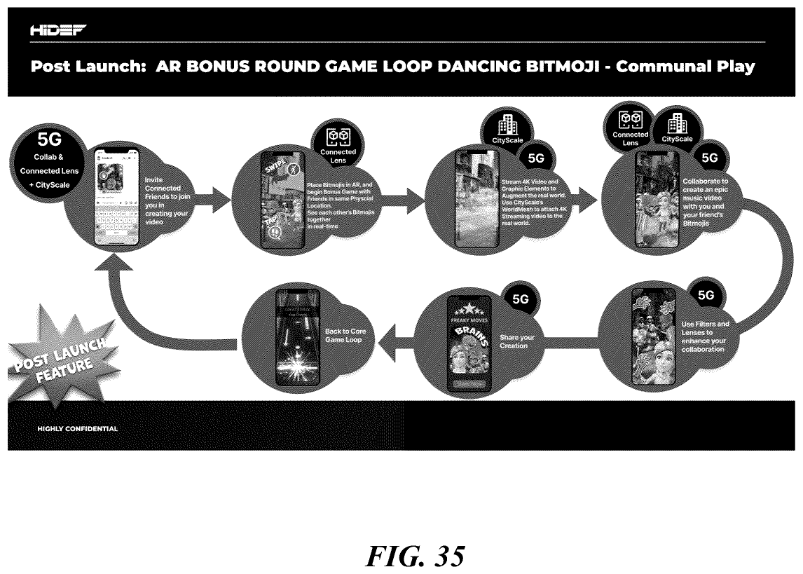

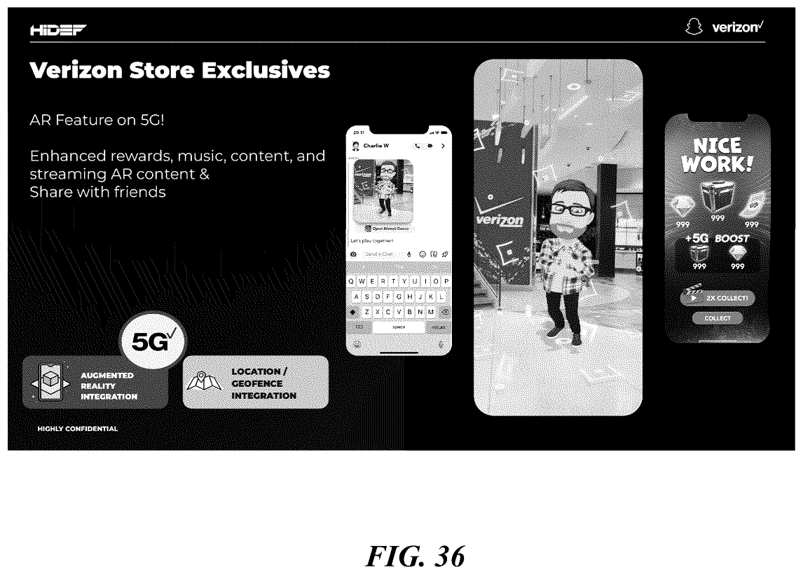

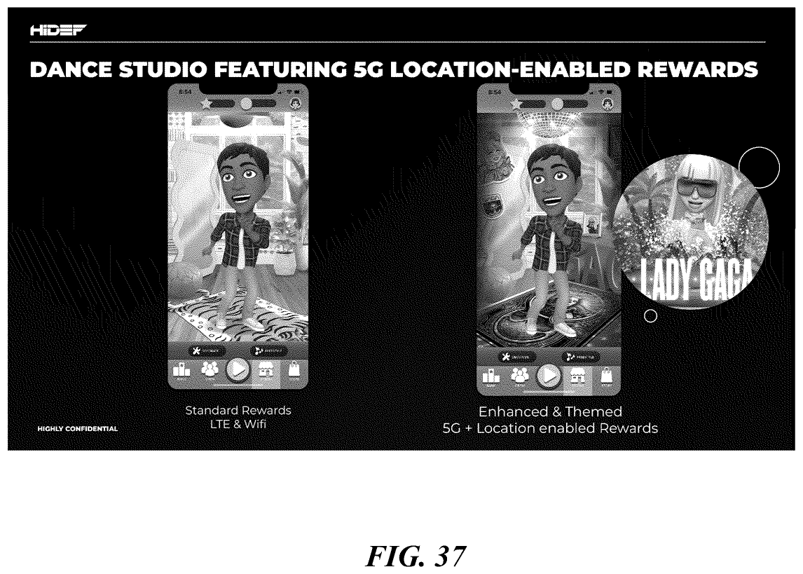

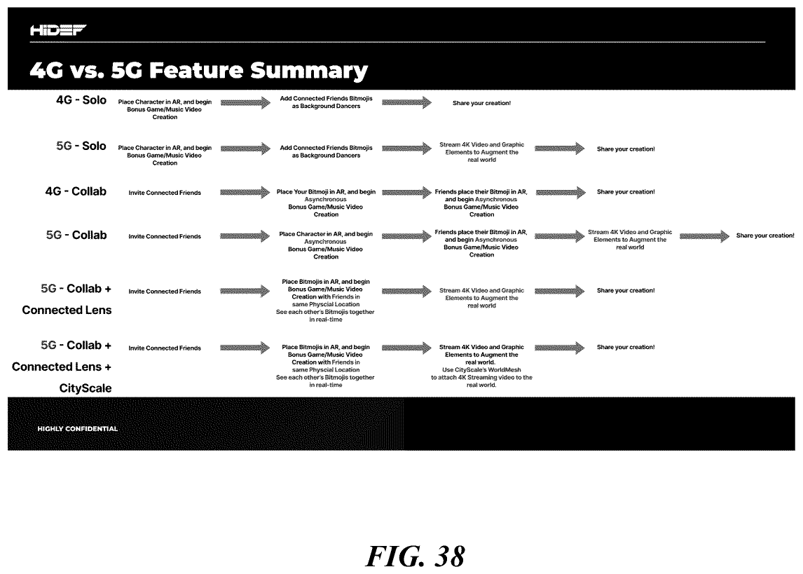

Referring to FIGS. 27 through 39, in one or more aspects, a user may be able to create animations or video, such as a music video, using special avatar or bitmoji characters, including without limitation the user's bitmoji or bitmoji of others known to the user. In the video, the user may, for example, edit the background environment to include other avatars or bitmojis. In one scenario, the additional avatars in the background may be selected from people who are in the user's friends list or contacts folder. The user may also invite one or more other users to collaborate in creating the music video, for example, by sending a link to the video in a text message. Once the other users complete their collaboration (e.g., by editing or adding new features to the video), the features may be added to the music video created by the user.

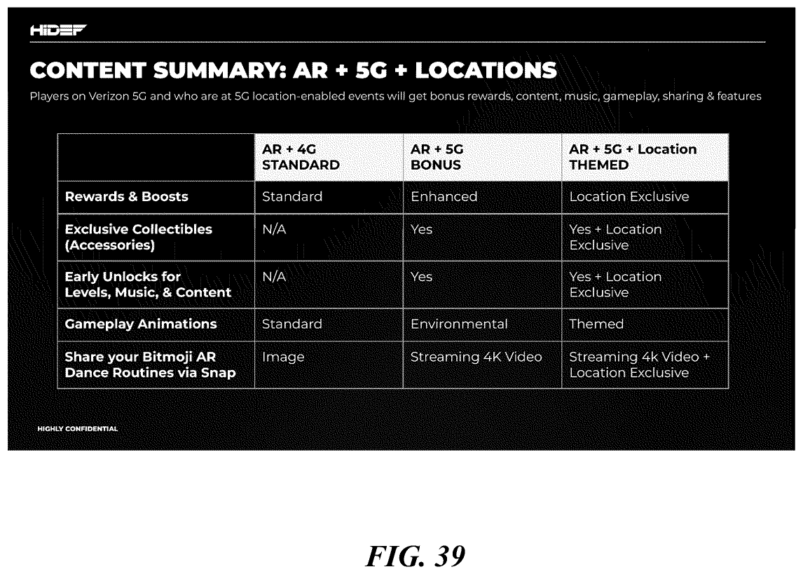

In certain implementations, the various features created by a plurality of users may be combined (e.g., by way of synchronization of multiple separately created videos with various features) to create a music video that combines all or selected features from one or more user creations. One or more features may be added or removed by the participating users or users who are invited to collaborate. Such features may include graphical filters and lenses, change or adjustments in camera angles, digital expression inserts, and augmented or virtual reality features. The users who collaborate or participate in contributing to a music video may receiving certain credits, awards or bonuses depending on the contribution level or creativity as shown in FIG. 39.

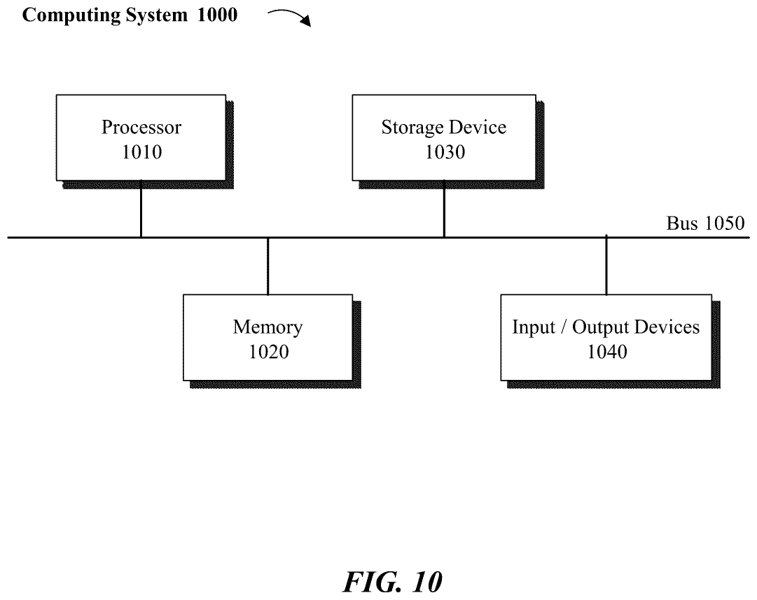

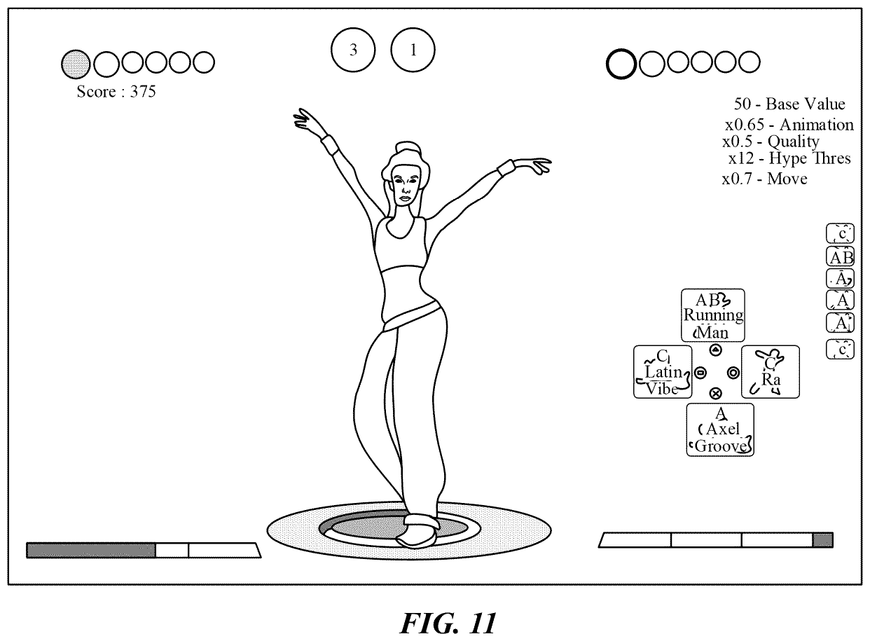

Referring to FIG. 10, a block diagram illustrating a computing system 1000 consistent with one or more embodiments is provided. The computing system 1000 may be used to implement or support one or more platforms, infrastructures or computing devices or computing components that may be utilized, in example embodiments, to instantiate, implement, execute or embody the methodologies disclosed herein in a computing environment using, for example, one or more processors or controllers, as provided below.

As shown in FIG. 3, the computing system 1000 can include a processor 1010, a memory 1020, a storage device 1030, and input/output devices 1040. The processor 1010, the memory 1020, the storage device 1030, and the input/output devices 1040 can be interconnected via a system bus 1050. The processor 1010 is capable of processing instructions for execution within the computing system 1000. Such executed instructions can implement one or more components of, for example, a cloud platform. In some implementations of the current subject matter, the processor 1010 can be a single-threaded processor. Alternately, the processor 1010 can be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 can be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet).

In some implementations of the current subject matter, the computing system 1000 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1040. The user interface can be generated and presented to a player by the computing system 1000 (e.g., on a computer screen monitor, etc.).

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a player, one or more aspects or features of the subject matter described herein may be implemented on a computer having a display device, such as for example a cathode ray tube (CRT) or a liquid crystal display (LCD) or a light emitting diode (LED) monitor for displaying information to the player and a keyboard and a pointing device, such as for example a mouse or a trackball, by which the player may provide input to the computer. Other kinds of devices may be used to provide for interaction with a player as well. For example, feedback provided to the player may be any form of sensory feedback, such as for example visual feedback, auditory feedback, or tactile feedback; and input from the player may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

FIGS. 11 through 26 provide examples of user interfaces and features, whether functional, structural, or graphical, that may be utilized or adopted in accordance with one or more embodiments to enable a player to interact with and better understand certain features and aspects of the game environment as disclosed herein and above. It is noteworthy that the depiction of various features, figures, backgrounds, and other graphical user interfaces, components or instruments are provided by way of example. These examples are non-limiting in nature and should not be construed as narrowing the scope of the disclosed subject matter to the particular details.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal.

The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

### Copyright & Trademark Notices

A portion of the disclosure of this patent document may contain material, which is subject to copyright protection. The owner has no objection to facsimile reproduction by any one of the patent documents or the patent disclosure, as it appears in the Patent and Trademark Office patent files or records, but reserves all copyrights whatsoever. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

What is claimed is:

1. A computer-implemented system for controlling animated renderings on a display device communicatively coupled to a controller device, the system comprising one or more processors for executing logic code causing the one or more processors to perform operations comprising:
associating a plurality of animation segments, graphically implemented over a video game platform, to a plurality of corresponding virtual cards in a first virtual deck, a virtual card in the plurality of virtual cards being selectable by a user for animating an avatar displayed on the display device,
the avatar being animatable according to movements captured in a corresponding animation segment in the plurality of animation segments included in a virtual card selected by the user;
in response to user interaction with one or more input elements on the controller device, animating the avatar according to animation segments in a selected virtual card having a plurality of animation segments; and
generating a visual guide providing feedback about synchronization status between animated movements performed by the avatar and a musical beat to which the avatar is animated by the user.

2. The system of claim 1, wherein the visual guide comprises one or more user-perceptible elements that allow the user to follow the musical beat and attempt to synchronize timing of the animated movements.

3. The system of claim 2, wherein the user viewing the one or more user-perceptible elements is able to receive feedback as to when to switch from one virtual card to another.

4. The system of claim 3, wherein the one or more user-perceptible elements include a status bar with progression markers as movement indicators.

5. The system of claim 4, wherein the status bar is a vertical or a horizontal GUI ruler interface with the progression markers being presented as projections in the GUI rule.

6. The system of claim 5, wherein position of the progression markers corresponds to the musical beat or when the musical beat changes.

7. The system of claim 2, wherein in response to a user synchronizing the timing of the animated movements with the musical beat within a predetermined threshold, the user receives at least one award.

8. The system of claim 7, wherein the at least one award is accumulated as hype or adrenalin measurable or collectable by the user.

9. The system of claim 8, wherein the accumulated hype or adrenaline is manifested as at least one of a visual halo or an aura around the avatar, or in form of audio or haptic feedback.

10. The system of claim 9, wherein the manifestation of the hype or adrenaline assumes an increased intensity as the accumulated hype or adrenaline increases.

11. The system of claim 10, wherein when the intensity of the accumulated hype or adrenaline reaches a first threshold, the user may earn additional rewards or an ability to cause the avatar to perform one or more special movements.

12. The system of claim 10, wherein when the intensity of the accumulated hype or adrenaline reaches a first threshold, a visually intensified projection is generated around the avatar as the avatar movements are graphically displayed representing intensified energy.

13. The system of claim 8, wherein the accumulated hype or adrenaline is manifested by a shift in color or color intensity in the avatar's environment.

14. The system of claim 13, wherein the avatar's environment includes at least one or more of a crowed, a figure, an object, a sculpture, or an area of a dance stage in which the avatar is being animated.

15. A computer-implemented system for controlling animated renderings on a display device communicatively coupled to a controller device, the system comprising one or more processors for executing logic code causing the one or more processors to perform operations comprising:
associating a plurality of animation segments, graphically implemented over a video game platform, to a plurality of corresponding virtual cards in a first virtual deck, a virtual card in the plurality of virtual cards being selectable by a user for animating an avatar displayed on the display device,
the avatar being animatable according to movements captured in a corresponding animation segment in the plurality of animation segments included in a virtual card selected by the user;
in response to user interaction with one or more input elements on the controller device, animating the avatar according to animation segments in a selected virtual card having a plurality of animation segments; and
awarding the user, in response to the user causing the avatar to be animated in accordance with feedback provided by one or more members of an audience viewing the avatar's performance.

16. The system of claim 15, wherein the feedback comprises at least one or more of a requested costume worn by the avatar, an audience gesture, a request avatar animation, or other acts that are requested by one or more members of the audience.

17. A computer-implemented system for controlling animated renderings on a display device communicatively coupled to a controller device, the system comprising one or more processors for executing logic code causing the one or more processors to perform operations comprising:
associating a plurality of animation segments, graphically implemented over a video game platform, to a plurality of corresponding virtual cards in a first virtual deck, a virtual card in the plurality of virtual cards being selectable by a user for animating an avatar displayed on the display device,
the avatar being animatable according to movements captured in a corresponding animation segment in the plurality of animation segments included in a virtual card selected by the user;
in response to user interaction with one or more input elements on the controller device, animating the avatar according to animation segments in a selected virtual card having a plurality of animation segments; and
providing feedback to the user, the feedback comprising one or more of an audio feedback, a visual feedback, a haptic feedback, or a performance metric.

18. The system of claim 15, wherein the visual feedback comprises color changes in the avatar's environment, a color indicating an expected mood associated with at least one type of animation segment.

19. The system of claim 18, wherein a plurality of colors are associated with a plurality of moods, a first color from among the plurality of colors corresponding to a first mood from among the plurality of moods.

20. The system of claim 19, wherein a plurality of virtual cards are associated with the plurality of colors, a first color from among the plurality of colors corresponding to a first virtual card from among the plurality of virtual cards.
